(19) United States
(12) Patent Application Publication
(10) Pub. No.: US 2018/0286089 A1
(43) Pub. Date: Oct. 4, 2018

(54) ELECTRONIC DEVICE AND METHOD FOR PROVIDING COLORABLE CONTENT

(71) Applicant: Samsung Electronics Co., Ltd., Suwon-si (KR)

(72) Inventors: Young-Dae LEE, Daegu (KR); Doo-Yong PARK, Gumi-si (KR); Young-Gyun LEE, Gumi-si (KR); Eun-Yeung LEE, Gumi-si (KR)

(21) Appl. No.: 15/889,597

(22) Filed: Feb. 6, 2018

(30) Foreign Application Priority Data
Mar. 31, 2017 (KR) 10-2017-0041904

(51) Int. Cl. G06T 11/20; G06T 11/00; G06T 7/90; G06T 11/60; G06K 9/00; G09B 11/10

(52) U.S. Cl. CPC G06T 11/203; G06T 11/001; G06T 7/90; G06T 2207/30201; G06K 9/00268; G09B 11/10; G06T 2207/10024; G06T 11/60

(57) ABSTRACT

An electronic device and method for providing colorable content are provided. The electronic device includes a display, at least one processor electrically connected to the display, and a memory electrically connected with the at least one processor. The memory stores instructions that, when executed, enable the at least one processor to obtain a first image, receive a first input, change a texture attribute of the first image based on the first input to generate at least one second image, generate a final image including colorable areas based on at least one color element for one selected from among the at least one second image, and display the final image through the display.

### CROSS-REFERENCE TO RELATED APPLICATION(S)

This application claims the benefit under 35 U.S.C. § 119(a) of a Korean patent application filed on Mar. 31, 2017 in the Korean Intellectual Property Office and assigned Serial number 10-2017-0041904, the entire disclosure of which is hereby incorporated by reference.

### TECHNICAL FIELD

The present disclosure relates to electronic devices and methods for providing colorable content.

### BACKGROUND

A coloring book is a type of book containing line art to which people are intended to add color using coloring tools, such as crayons, colored pencils, marker pens, paint or other artistic media. Traditional coloring books are printed on paper and published. Coloring books have seen wide applications in various fields, intended not only for children but also for adults.

Coloring books have recently been provided free or for a fee to users in the form of online content such as applications. More and more people prefer such coloring books that have form of online content to regular ones.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a digital coloring book that utilizes only contour information about at least one object in the image, imposing a limitation on the user producing his desired content.

According to various embodiments of the present disclosure, there may be provided an electronic device and method for providing colorable content which is produced using the user's desired images, e.g., photos or pictures.

According to an embodiment of the present disclosure, there may be provided an electronic device and method for providing colorable content.

In accordance with an aspect of the present disclosure, an electronic device may be provided. The electronic device may include a display, at least one processor electrically connected to the display, and a memory electrically connected with the at least one processor, wherein the memory stores instructions, when executed, enable the at least one processor to obtain a first image, receive a first input, change a texture attribute of the first image based on the first input to generate at least one second image, generate a final image including a plurality of colorable areas based on at least one color element for one selected from among the at least one second image, and display the final image through the display.

In accordance with another aspect of the present disclosure, a method for an electronic device may be provided. The method may include obtaining a first image, receiving a first input, changing a texture attribute of the first image based on the first input to generate at least one second image, and generating a final image including a plurality of colorable areas based on at least one color element for one selected from among the at least one second image.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIG. 4 is a block diagram illustrating an electronic device according to an embodiment of the present disclosure;

FIG. 5 is a block diagram illustrating program modules for execution in an execution environment of an electronic device according to an embodiment of the present disclosure;

FIG. 6 is a flowchart illustrating a method for providing colorable content in an electronic device according to an embodiment of the present disclosure;

FIG. 7 is a flowchart illustrating a method for providing colorable content in an electronic device according to an embodiment of the present disclosure;

FIG. 8 is a flowchart illustrating a method for providing colorable content in an electronic device according to an embodiment of the present disclosure;

FIG. 9 is a flowchart illustrating a method for providing colorable content in an electronic device according to an embodiment of the present disclosure;

FIG. 10 is a flowchart illustrating a method for providing colorable content in an electronic device according to an embodiment of the present disclosure;

FIGS. 11A, 11B, 11C, and 11D are views illustrating examples of a first image, a second image, and a final image according to embodiments of the present disclosure;

FIGS. 12A, 12B, 12C, 12D, 12E, and 12F are views illustrating examples of a coloring-related user interface according to an embodiment of the present disclosure;

FIGS. 13A, 13B, 13C, 13D, and 13E are views illustrating examples of a coloring-related user interface according to an embodiment of the present disclosure;

FIGS. 14A, 14B, and 14C are views illustrating examples of a coloring-related user interface according to an embodiment of the present disclosure;

FIGS. 15A and 15B are views illustrating examples of a coloring-related user interface according to an embodiment of the present disclosure;

FIGS. 16A, 16B, and 16C are views illustrating examples of a coloring-related user interface according to an embodiment of the present disclosure;

FIG. 17 is a flowchart illustrating the operation of changing the complexity of a pattern area in an electronic device according to an embodiment of the present disclosure; and

FIGS. 18A and 18B are views illustrating examples of the operation of changing the complexity of a selected pattern area in an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The same or similar reference denotations may be used to refer to the same or similar elements throughout the specification and the drawings. It is to be understood that the singular forms “a,” “an,” and “the” include plural references unless the context clearly dictates otherwise. As used herein, the terms “A or B” or “at least one of A or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, or C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, examples of the smart home appliance may include at least one of a television, a digital versatile disc (DVD) player, an audio player, a refrigerator, an air conditioner, a cleaner, an oven, a microwave oven, a washer, a drier, an air cleaner, a set-top box, a home automation control panel, a security control panel, a television (TV) box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs), point of sales (POS) devices, or internet of things (IoT) devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves). According to embodiments of the present disclosure, the electronic device may be flexible or may be a combination of the above-enumerated electronic devices. According to an embodiment of the present disclosure, the electronic device is not limited to the above-listed embodiments. As used herein, the term “user” may denote a human or another device (e.g., an artificial intelligent electronic device) using the electronic device.

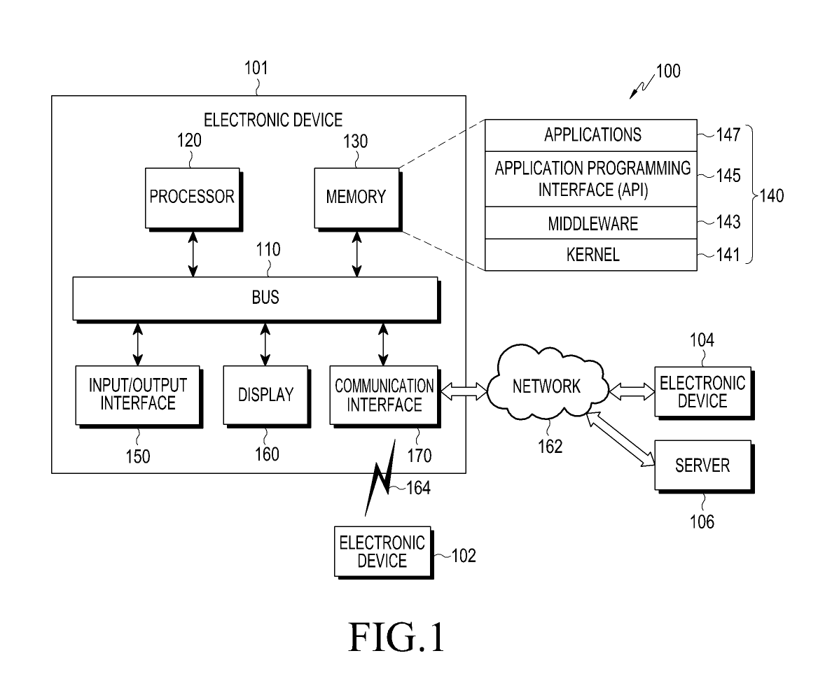

FIG. 1 illustrates a network environment including an electronic device according to an embodiment of the present disclosure.

Referring to FIG. 1, according to an embodiment of the present disclosure, an electronic device 101 is included in a network environment 100. The electronic device 101 may include a bus 110, a processor 120 (e.g., at least one processor), a memory 130, an input/output interface 150, a display 160, and a communication interface 170. In some embodiments, the electronic device 101 may exclude at least one of the components or may add another component.

The bus 110 may include a circuit for connecting the components 110 to 170 with one another and transferring communications (e.g., control messages or data) between the components.

The processor 120 may include one or more of a CPU, an AP, or a communication processor (CP). The processor 120 may perform control on at least one of the other components of the electronic device 101 or perform an operation or data processing relating to communication.

According to an embodiment of the present disclosure, the processor 120 may obtain a first image and generate a final image including a plurality of colorable areas using the obtained first image. The final image may correspond to the first image. The plurality of colorable areas may be formed with at least one line element distinguished from each other.

The memory 130 may include a volatile or non-volatile memory. For example, the memory 130 may store commands or data related to at least one other component of, e.g., the electronic device 101.

According to an embodiment of the present disclosure, the memory 130 may store software or a program 140. The program 140 may include, e.g., a kernel 141, middleware 143, an application programming interface (API) 145, an application program (or “application”) 147, or a location providing module (not shown). At least a portion of the kernel 141, middleware 143, or API 145 may be denoted an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. Further, the middleware 143 may process one or more task requests received from the application program 147 in order of priority. For example, the middleware 143 may assign a priority of using system resources (e.g., bus 110, processor 120, or memory 130) of the electronic device 101 to at least one of the application programs 147 and process one or more task requests. The API 145 is an interface allowing the application 147 to control functions provided from the kernel 141 or the middleware 143. For example, the API 145 may include at least one interface or function (e.g., a command) for filing control, window control, image processing or text control. For example, the input/output interface 150 may transfer commands or data input from the user or other external device to other component(s) of the electronic device 101 or may output commands or data received from other component(s) of the electronic device 101 to the user or other external devices.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. According to an embodiment of the present disclosure, the display 160 may include a touchscreen and may receive, e.g., a touch, gesture, proximity, drag, swipe, or hovering input using an electronic pen or a body portion of the user.

For example, the communication interface 170 may set up communication between the electronic device 101 and an external electronic device (e.g., a first electronic device 102, a second electronic device 104, or a server 106). For example, the communication interface 170 may be connected with the network 162 through wireless or wired communication to communicate with the external electronic device (e.g., the second external electronic device 104 or server 106).

The wireless communication may include cellular communication which uses at least one of, e.g., long term evolution (LTE), long term evolution—advanced (LTE-A), code division multiple access (CDMA), wideband code division multiple access (WCDMA), universal mobile telecommunication system (UMTS), wireless broadband (WiBro), or global system for mobile communication (GSM). According to an embodiment of the present disclosure, the wireless communication may include at least one of, e.g., wireless-fidelity (Wi-Fi), light-fidelity (Li-Fi), Bluetooth (BT), bluetooth low power (BLE), zigbee, near-field communication (NFC), magnetic secure transmission (MST), radio frequency (RF), or body area network (BAN) as denoted with element 164 of FIG. 1. According to an embodiment of the present disclosure, the wireless communication may include global navigation satellite system (GNSS). The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The first and second external electronic devices 102 and 104 each may be a device of the same or a different type from the electronic device 101.

According to an embodiment of the present disclosure, all or some of operations executed on the electronic device 101 may be executed on another or multiple other electronic devices (e.g., the electronic devices 102 and 104 or server 106).

According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

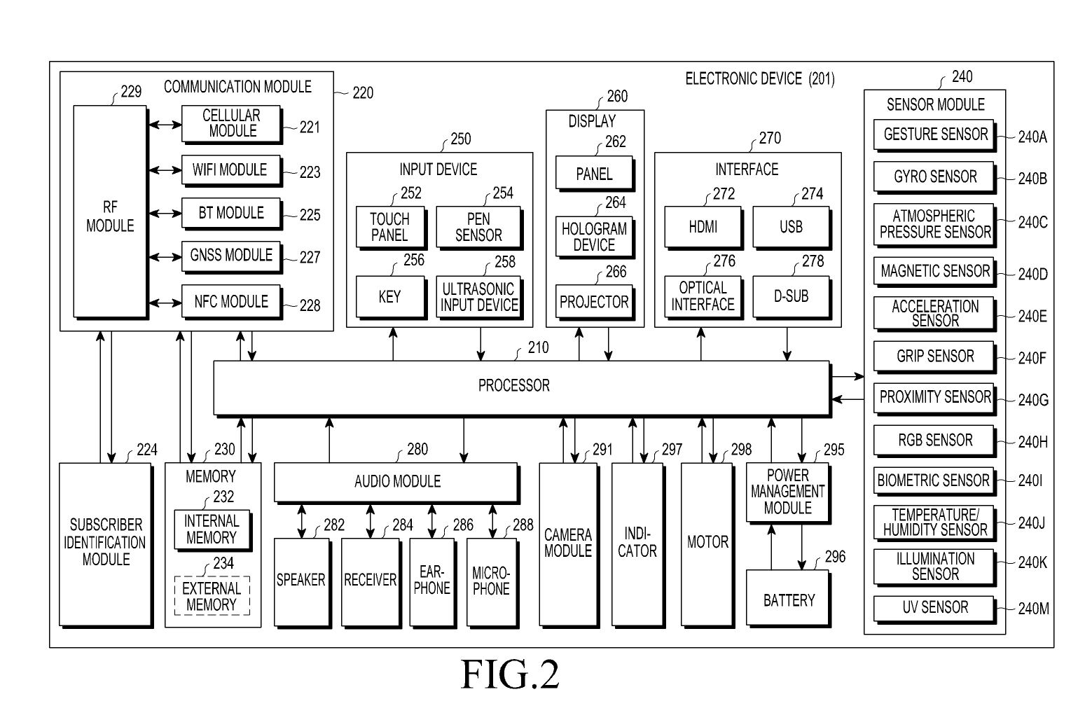

FIG. 2 is a block diagram illustrating an electronic device 201 according to an embodiment of the present disclosure. An electronic device 201 may include the whole or part of, e.g., the electronic device 101 of FIG. 2. The electronic device 201 may include one or more processors (e.g., APs) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control multiple hardware and software components connected to the processor 210 by running, e.g., an operating system or application programs, and the processor 210 may process and compute various data. The processor 210 may be implemented in, e.g., a system on chip (SoC).

According to an embodiment of the present disclosure, the processor 210 may further include a graphic processing unit (GPU) or an image signal processor (ISP). The processor 210 may include at least some (e.g., the cellular module 221) of the components shown in FIG. 2. The processor 210 may load a command or data received from at least one of other components (e.g., a non-volatile memory) on a volatile memory, process the command or data, and store resultant data in the non-volatile memory.

According to an embodiment of the present disclosure, the processor 210 may obtain a first image and generate a final image including a plurality of colorable areas using the obtained first image. The final image may correspond to the first image. The plurality of colorable areas may be formed with at least one line element distinguished from each other.

The communication module 220 may have the same or similar configuration to the communication interface 170. The communication module 220 may include, e.g., a cellular module 221, a Wi-Fi module 223, a BT module 225, a GNSS module 227, a NFC module 228, and a RF module 229. The cellular module 221 may provide voice call, video call, text, or Internet services through, e.g., a communication network. According to an embodiment of the present disclosure, the cellular module 221 may perform identification or authentication on the electronic device 201 in the communication network using a SIM 224 (e.g., the SIM card). According to an embodiment of the present disclosure, the cellular module 221 may perform at least some of the functions providable by the processor 210. According to an embodiment of the present disclosure, the cellular module 221 may include a CP. According to an embodiment of the present disclosure, at least some (e.g., two or more) of the cellular module 221, the Wi-Fi module 223, the BT module 225, the GNSS module 227, or the NFC module 228 may be included in a single integrated circuit (IC) or an IC package. The RF module 229 may transmit and receive, e.g., communication signals (e.g., RF signals). The RF module 229 may include, e.g., a transceiver, a power amp module (PAM), a frequency filter, a low noise amplifier (LNA), or at least one antenna. According to an embodiment of the present disclosure, at least one of the cellular module 221, the Wi-Fi module 223, the BT module 225, the GNSS module 227, or the NFC module 228 may communicate RF signals through a separate RF module. The subscription identification module 224 may include, e.g., a card including a SIM, or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 234 may include a flash drive, e.g., a compact flash (CF) memory, a secure digital (SD) memory, a micro-SD memory, a min-SD memory, an extreme digital (xD) memory, a multimedia card (MMC), or a Memory Stick™. The external memory 234 may be functionally or physically connected with the electronic device 201 via various interfaces.

For example, the sensor module 240 may measure a physical quantity or detect a motion state of the electronic device 201, and the sensor module 240 may convert the measured or detected information into an electrical signal. The sensor module 240 may include at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red-green-blue (RGB) sensor, a bio sensor 240I, a temperature/humidity sensor 240J, an illumination sensor 240K, or an Ultra Violet (UV) sensor 240M. Additionally or alternatively, the sensing module 240 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the sensing module. According to an embodiment of the present disclosure, the electronic device 201 may further include a processor configured to control the sensor module 240 as part of the processor 210 or separately from the processor 210, and the electronic device 201 may control the sensor module 240 while the processor 210 is in a sleep mode.

The input unit 250 may include, e.g., a touch panel 252, a (digital) pen sensor 254, a key 256, or an ultrasonic input device 258. The touch panel 252 may use at least one of capacitive, resistive, infrared (IR), or ultrasonic methods. The touch panel 252 may further include a control circuit. The touch panel 252 may further include a tactile layer and may provide a user with a tactile reaction. The (digital) pen sensor 254 may include, e.g., a part of a touch panel or a separate sheet for recognition. The key 256 may include e.g., a physical button, optical key or key pad. The ultrasonic input device 258 may sense an ultrasonic wave generated from an input tool through a microphone (e.g., the microphone 288) to identify data corresponding to the sensed ultrasonic wave.

The display 260 (e.g., the display 160) may include a panel 262, a hologram device 264, a projector 266, or a control circuit for controlling the same. The panel 262 may be implemented to be flexible, transparent, or wearable. The panel 262, together with the touch panel 252, may be configured in one or more modules. According to an embodiment of the present disclosure, the panel 262 may include a pressure sensor (or pose sensor) that may measure the strength of a pressure by the user's touch. The pressure sensor may be implemented in a single body with the touch panel 252 or may be implemented in one or more sensors separate from the touch panel 252. The hologram device 264 may make three dimensional (3D) images (holograms) in the air by using light interference. The projector 266 may display an image by projecting light onto a screen. The screen may be, for example, located inside or outside of the electronic device 201. The interface 270 may include e.g., a high definition multimedia interface (HDMI) 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition link (MHL) interface, a secure digital (SD) card/multimedia card (MMC) interface, or infrared data association (IrDA) standard interface.

The audio module 280 may converting, e.g., a sound signal into an electrical signal and vice versa. At least a part of the audio module 280 may be included in e.g., the input/output interface 145 as shown in FIG. 1. The audio module 280 may process sound information input or output through e.g., a speaker 282, a receiver 284, an earphone 286, or a microphone 288.

For example, the camera module 291 may be a device for capturing still images and videos, and may include, according to an embodiment of the present disclosure, one or more image sensors (e.g., front and back sensors), a lens, an image signal processor (ISP), or a flash such as an LED or xenon lamp.

The power manager module 295 may manage power of the electronic device 201, for example. According to an embodiment of the present disclosure, the power manager module 295 may include a power management Integrated circuit (PMIC), a charger IC, or a battery or fuel gauge. The PMIC may have a wired or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal to a mechanical vibration and may generate a vibrational or haptic effect. The electronic device 201 may include a mobile TV supporting device (e.g., a GPU) that may process media data as per, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments, the electronic device (e.g., the electronic device 201) may exclude some elements or include more elements, or some of the elements may be combined into a single entity that may perform the same function as by the elements before combined.

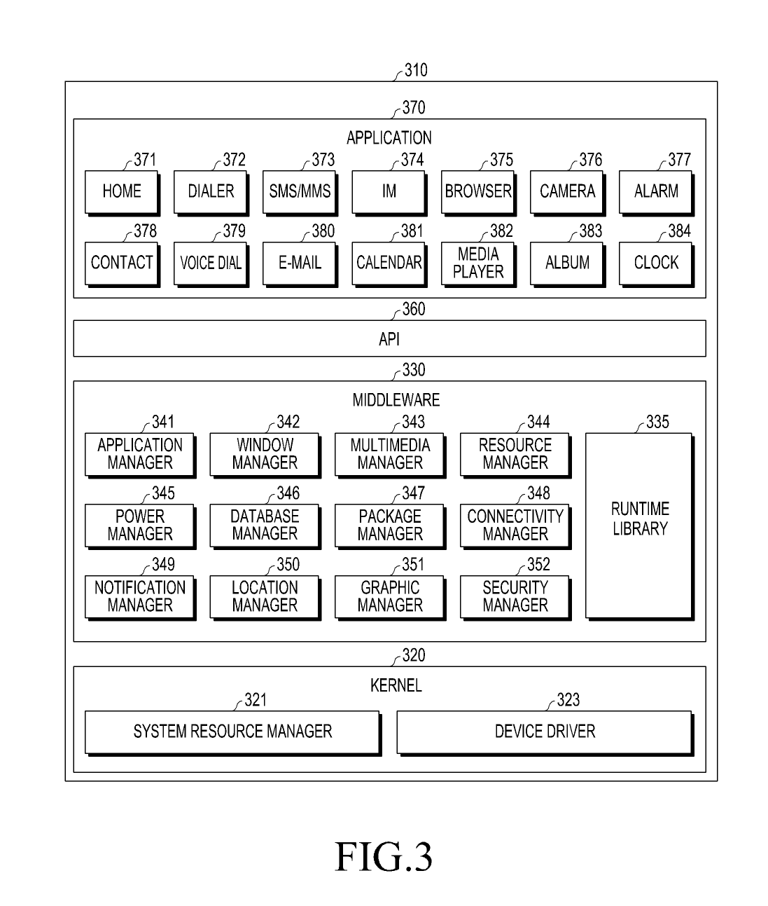

FIG. 3 is a block diagram illustrating a program module according to an embodiment of the present disclosure. According to an embodiment of the present disclosure, the program module 310 (e.g., the program 140) may include an operating system (OS) controlling resources related to the electronic device (e.g., the electronic device 101) or various applications (e.g., the application processor 147) driven on the operating system. The operating system may include, e.g., Android™, iOS™, Windows™, Symbian™, Tizen™, or Bada™.

Referring to FIG. 3, the program module 310 may include a kernel 320 (e.g., the kernel 141), middleware 330 (e.g., the middleware 143), an API 360 (e.g., the API 145), or an application 370 (e.g., the application program 147). At least a part of the program module 310 may be preloaded on the electronic device or may be downloaded from an external electronic device (e.g., the electronic devices 102 and 104 or server 106).

The kernel 320 may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a BT driver, a shared memory driver, a USB driver, a keypad driver, a Wi-Fi driver, an audio driver, or an inter-process communication (IPC) driver. The middleware 330 may provide various functions to the application 370 through the API 360 so that the application 370 may use limited system resources in the electronic device or provide functions jointly required by applications 370. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or arithmetic function processing. The application manager 341 may manage the life cycle of, e.g., the applications 370. The window manager 342 may manage GUI resources used on the screen. The multimedia manager 343 may grasp formats necessary to play media files and use a codec appropriate for a format to perform encoding or decoding on media files. The resource manager 344 may manage the source code or memory space of the application 370. The power manager 345 may manage, e.g., the capacity, temperature, or power of the battery and determine and provide power information necessary for the operation of the electronic device using a corresponding piece of information of such. According to an embodiment of the present disclosure, the power manager 345 may interwork with a basic input/output system (BIOS). The database manager 346 may generate, search, or vary a database to be used in the applications 370. The package manager 347 may manage installation or update of an application that is distributed in the form of a package file.

The connectivity manager 348 may manage, e.g., wireless connectivity. The notification manager 349 may provide an event, e.g., arrival message, appointment, or proximity alert, to the user. The location manager 350 may manage, e.g., locational information on the electronic device. The graphic manager 351 may manage graphic effects to be offered to the user and their related user interface. The security manager 352 may provide system security or user authentication, for example. According to an embodiment of the present disclosure, the middleware 330 may include a telephony manager for managing the voice or video call function of the electronic device or a middleware module able to form a combination of the functions of the above-described elements. According to an embodiment of the present disclosure, the middleware 330 may provide a module specified according to the type of the operating system. The middleware 330 may dynamically omit some existing components or add new components. The API 360 may be a set of, e.g., API programming functions and may have different configurations depending on operating systems. For example, in the case of Android or iOS, one API set may be provided per platform, and in the case of Tizen, two or more API sets may be offered per platform.

The application 370 may include an application that may provide, e.g., a home 371, a dialer 372, a short messaging system (SMS)/multimedia messaging m service (MMS) 373, an instant message (IM) 374, a browser 375, a camera 376, an alarm 377, a contact 378, a voice dial 379, an email 380, a calendar 381, a media player 382, an album 383, or a clock 384, a health-care (e.g., measuring the degree of workout or blood sugar), or provision of environmental information (e.g., provision of air pressure, moisture, or temperature information). According to an embodiment of the present disclosure, the application 370 may include an information exchanging application supporting information exchange between the electronic device and an external electronic device. Examples of the information exchange application may include, but is not limited to, a notification relay application for transferring specific information to the external electronic device, or a device management application for managing the external electronic device. For example, the notification relay application may transfer notification information generated by other application of the electronic device to the external electronic device or receive notification information from the external electronic device and provide the received notification information to the user. For example, the device management application may install, delete, or update a function (e.g., turn-on/turn-off the external electronic device (or some elements) or adjusting the brightness (or resolution) of the display) of the external electronic device communicating with the electronic device or an application operating on the external electronic device. According to an embodiment of the present disclosure, the application 370 may include an application (e.g., a health-care application of a mobile medical device) designated according to an attribute of the external electronic device. According to an embodiment of the present disclosure, the application 370 may include an application received from the external electronic device. At least a portion of the program module 310 may be implemented (e.g., executed) in software, firmware, hardware (e.g., the processor 210), or a combination of at least two or more thereof and may include a module, program, routine, command set, or process for performing one or more functions.

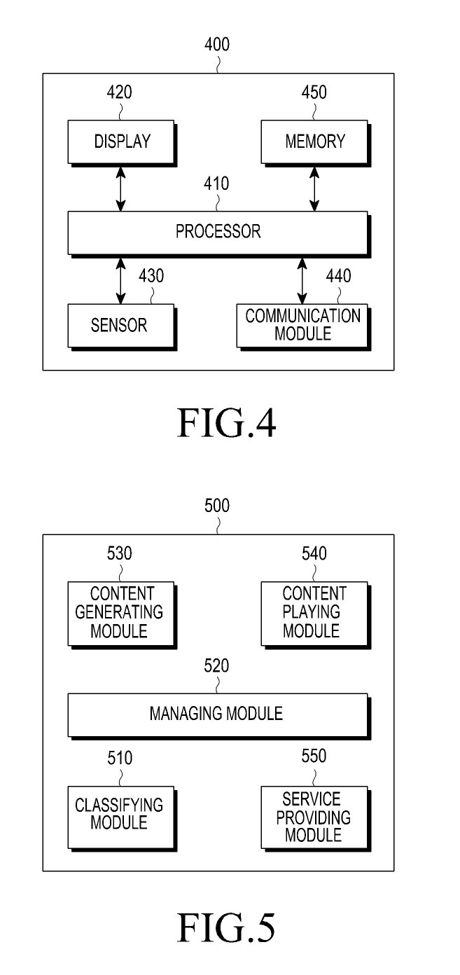

FIG. 4 is a block diagram illustrating an electronic device according to an embodiment of the present disclosure.

Referring to FIG. 4, an electronic device 400 may include a processor 410, a display 420, a sensor 430, a communication module 440, and a memory 450.

According to an embodiment of the present disclosure, the processor 410 may obtain a first image (or raw image), receive a first input, change the texture attribute of the first image based on the first input to generate at least one second image (or candidate image), and generate (or provide) a final image including a plurality of colorable areas based on at least one line element for one selected from among the at least one second image generated. For example, the first input may be the user's input. According to an embodiment of the present disclosure, the processor 410 may change the texture attribute of the obtained first image upon obtaining the first image with no input. The first image may include an image obtained using the sensor 430 (e.g., an image sensor), some of continuous images of a video, or an image downloaded from an external electronic device. The final image may correspond to the first image. The plurality of colorable areas may be formed with at least one line element distinguished from each other. The texture attribute may include a line attribute for a line element representing a boundary between colors having different attributes, a face attribute for a face element forming an enclosed area by the line element, and a color attribute for a color element corresponding to the line element or face element. The color attribute may include at least one of color, brightness, and chroma. The line attribute may include the texture (e.g., such as that of a pencil, pen, crayon, pastel, oil painting, watercolor, or marker) or thickness of the line. The face element may include the size, shape, texture (such as of a pencil, pen, crayon, pastel, oil painting, watercolor, or marker) of the face. The final image may be a black-and-white drawing (e.g., a drawing constituted of black line elements on a white background image) including a plurality of colorable areas formed by at least one line element.

For example, candidate images whose texture attribute has been changed may be represented as a drawing made by coloring tools, such as a pencil, oil color, watercolor, or marker.

According to an embodiment of the present disclosure, the processor 410 may perform at least one of first image processing to adjust the resolution or pixel count of the obtained first image and second image processing for removing noise from the first image. For example, the first image processing may be performed in a resampling scheme, or the second image processing may be performed in a morphology filtering scheme.

According to an embodiment of the present disclosure, the processor 410 may classify at least one color element for the selected second image, receive a second input, select a complexity for the second image based on the second input, determine at least part of the at least one color element classified as a similar color element based on the selected complexity, and generate the final image based on the determined similar color element. The second input may be the user's input. According to an embodiment of the present disclosure, the processor 410 may select the complexity for the second image with no input. The processor 410 may set a wider similarity range for at least one color element as the complexity decreases and a narrower similarity range for at least one color element as the complexity increases. For example, where the complexity selected by the second input is high, the processor 410 may determine whether a first difference between a first color element and a second color element is smaller than a first threshold, and when the first difference is smaller than the first threshold, the processor 410 may determine that the first color element and the second color element are similar color elements. Where the complexity selected by the second input is low, the processor 410 may determine whether a second difference (e.g., a value larger than the first difference) between the first color element and a third color element is larger than the first threshold and is smaller than a second threshold (e.g., a value larger than the first threshold), and when the second difference is larger than the first threshold and smaller than the second threshold, the processor 410 may determine that the first color element and the third color element are similar color elements.

According to an embodiment of the present disclosure, the processor 410 may change the boundary between the face elements to generate at least one second image. Each of the at least one second image may have a different texture attribute. For example, the processor 410 may analyze each of at least one face element included in the first image to identify the color value of at least one color element, and the processor 410 may generate at least one face area including a set of face elements having a color value not less than a threshold among the at least one color value identified. The threshold may be set as various values. For example, the processor 410 may perform the above operations using a clustering scheme.

According to an embodiment of the present disclosure, the processor 410 may generate at least one third image including at least one face area generated and combine (or merge) at least some of the at least one third image generated or the raw image, generating at least one second image. In each of the at least one third image, at least one face area may have a different color value. For example, the processor 410 may merge one having at least one face area with a first color value among the at least one third image with another having at least one face area with a second color value among the at least one third image, generating the second image.

According to an embodiment of the present disclosure, the processor 410 may adjust the degree of varying the texture attribute for at least one face element and vary the boundary between the face elements having different texture attributes based on the adjusted degree of variation. According to an embodiment of the present disclosure, the processor 410 may also adjust the variation information about the texture attribute by an input from the user.

According to an embodiment of the present disclosure, the processor 410 may determine face elements having color information not less than a threshold among at least one face element included in the second image using different threshold color information items (e.g., threshold color values, threshold brightness values, or threshold chroma values). As per a result of the determination, the processor 410 may generate at least one face area including a set for face elements having color information not less than the threshold and generate at least one second image including at least some of the at least one face area generated. The set of face elements may be varied depending on different threshold color information items.

For example, the processor 410 may determine whether the color value (or brightness value or chroma value) of each of the at least one face element is not less than the threshold color value (or threshold brightness value or threshold chroma value).

According to an embodiment of the present disclosure, the processor 410 may insert a pattern image to at least some of the at least one face area, generating at least one second image. The pattern image may be an image in which unit patterns formed by at least one line are continuously arranged.

According to an embodiment of the present disclosure, the processor 410 may generate at least one second image in which the number of unit patterns included in at least part of the pattern image increases as the unit patterns shrink. According to an embodiment of the present disclosure, the processor 410, upon receiving a user input, may perform the above-described operations based on the user input.

According to an embodiment of the present disclosure, the processor 410 may change the texture attribute for at least one face element corresponding to a second area other than a first area of the first image, generating at least one second image.

According to an embodiment of the present disclosure, the processor 410 may split the image corresponding to the first area of the first image and vary the texture attribute for at least one face element corresponding to the second area except for the split image corresponding to the first area in the first image, generating at least one second image. For example, the processor 410 may generate at least one second image in which the boundary between face elements has been varied corresponding to the second area. Each of the at least one second image may have a different attribute. The processor 410 may generate a fourth image including at least one line element based on one selected from among the at least one second image generated and merge the generated fourth image with the split image, providing the final image.

According to an embodiment of the present disclosure, the processor 410 may provide color information corresponding to each of the plurality of colorable areas formed by at least one line element included in the final image. For example, the processor 410 may provide information (e.g., an indicator (or number)) indicating the color value for each of at least one face area included in the selected second image.

According to an embodiment of the present disclosure, the processor 410 may obtain a first image, pre-process the obtained first image, vary the texture attribute for face elements of the pre-processed first image to generate a second image, and post-process the generated second image, providing a final image including at least one line element for the post-processed second image.

According to an embodiment of the present disclosure, the processor 410 may vary the resolution and pixel count of the first image, performing image processing to increase the size or remove noise. The processor 410 may select a particular area of the first image and pre-process the partial image corresponding to the rest except for the particular area selected.

According to an embodiment of the present disclosure, the processor 410 may identify the color information (e.g., color, brightness, or chroma) corresponding to each of the plurality of face elements included in the first image and set, as at least one face area, a set of at least one face element having the color information not less than a threshold based on the identified color information. The processor 410 may determine whether the color value is not less than the threshold color value, whether the brightness value is not less than the threshold brightness value, or whether the chroma value is not less than the threshold chroma value. For example, the processor 410 may set a set for face elements of a first color (e.g., red) and face elements of a second color (e.g., blue) as face area of a third color (e.g., brown).

According to an embodiment of the present disclosure, the processor 410 may generate at least one layer image (e.g., at least one third image) including each of the at least one face area as set and merge (or combine) the first image and at least some of the at least one layer image generated, generating the second image. For example, the processor 410 may generate a first layer image including a brown face area, a second layer image including an orange face area, and a third layer image including a yellow face area and generate the second image including at least one of the brown, orange, and yellow face areas.

According to an embodiment of the present disclosure, the processor 410 may add a pattern image to at least portion of the generated second image, add a pattern image to the face area having particular color information, or add a pattern image to a selected face area. The pattern image may be configured to have unit patterns repeating or various forms of pattern areas (e.g., various forms of face areas) based on a particular template.

According to an embodiment of the present disclosure, the processor 410 may make a setting to increase the number of unit patterns or pattern areas included in at least a portion while reducing the size of the unit patterns or pattern areas so as to increase the pattern complexity (or accuracy) for at least part of the pattern image.

According to an embodiment of the present disclosure, the processor 410 may select at least one pattern area of the pattern image and vary the pattern complexity for at least one pattern area selected. The selection may be performed by the user's input or device (or processor). For example, the user's input may include at least one of a touch-drag-and-drop, a force touch, or a long press. The input is not limited to those enumerated above, and other various inputs are also possible for selection.

The processor 410, upon sensing a force touch or long press, may enter an area selection mode to select at least one pattern area. Upon sensing a touch or touch-drag-and-drop, the processor 410 may determine the distance between the plurality of input points corresponding to the second image and determine the pattern complexity for at least one pattern area based on the determined distance. The processor 410 may adjust the size or number of at least one pattern area based on the determined pattern complexity. For example, where the determined distance is a first distance, the processor 410 may vary at least one pattern area to have a first size and a first number based on first pattern complexity corresponding to the first distance. Where the determined distance is a second distance which is larger than the first distance, the processor 410 may vary at least one pattern area to have a second size, smaller than the first size, and a second number, larger than the first number, based on second pattern complexity corresponding to the second distance. Where the determined distance is a third distance which is smaller than the first distance, the processor 410 may vary at least one pattern area to have a third size, larger than the first size, and a third number, smaller than the first number, based on third pattern complexity corresponding to the third distance.

According to an embodiment of the present disclosure, the processor 410 may perform image processing to enhance the quality of the generated second image or the second image having the pattern image partially added thereto. The processor 410 may perform post-processing on the second image using various image processing schemes to raise resolution and remove noise.

According to an embodiment of the present disclosure, the processor 410 may identify at least one line element representing the boundary between the plurality of face areas included in the post-processed second image and generate a final image including at least one line element identified. For example, the final image may include colorable areas formed by at least one line element.

According to an embodiment of the present disclosure, the processor 410 may provide color information corresponding to the colorable areas formed by at least one line element included in the generated final image. The colorable areas may correspond to the plurality of face areas of the second image. The processor 410 may provide color information about the plurality of face areas corresponding to the colorable areas.

According to an embodiment of the present disclosure, the processor 410 may provide a function for coloring the generated final image. For example, the processor 410 may provide a user interface corresponding to the coloring function related to at least one coloring tool. For example, the user interface may include a display area for displaying the final image, a preview area for previewing the first image or second image related to the final image, and a tool area corresponding to the coloring function related to at least one coloring tool (e.g., a pencil, charcoal, color pencil, pen, marker, brush (for oil or watercolor painting), pastel, and spray).

According to an embodiment of the present disclosure, the processor 410 may color at least part of the final image using the coloring function as per an input and generate a video (e.g., a gif file or mpeg file) including colored images continuously stored according to order or time of coloring of at least part of the final image. For example, the processor 410 may color, in a first color, a first colorable area among the plurality of colorable areas in the final image, and store the final image including the first colorable area colored in the first color. The processor 410 may color a second colorable area in a second color and store the final image including the first colorable area colored in the first color and the second colorable area colored in the second color. According to an embodiment of the present disclosure, the processor 410 may perform coloring by the user's input. The processor 410 may generate a video using the stored final images and provide the generated video.

According to an embodiment of the present disclosure, the processor 410 may provide content that is at least partially the same or similar to the generated final image.

According to an embodiment of the present disclosure, the processor 410 may search the contents stored in the memory 450 for content at least partially similar to the final image and provide or recommend the searched content. The processor 410 may identify at least one object included in the final image based on at least one line element included in the final image and search for content including an object at least partially similar to the identified object. For example, where the identified object is a human figure, the processor 410 may search for content related to the figure.

According to an embodiment of the present disclosure, the processor 410 may also search for content having an attribute at least partially similar to the attribute (e.g., shape or number) of the colorable areas formed by at least one line element.

According to an embodiment of the present disclosure, the processor 410 may also search for content having a texture attribute at least partially similar to the texture attribute for the first or second image related to the final image. For example, the processor 410 may search for content having a line attribute, face attribute, or color attribute at least partially similar to the line attribute, face attribute, or color attribute for the first or second image.

According to an embodiment of the present disclosure, the processor 410 may send a request for content at least partially similar to the final image to an external electronic device and receive the content at least partially similar to the final image from the external electronic device.

According to an embodiment of the present disclosure, the processor 410 may analyze the raw image (such as of offline coloring content or offline coloring book content) captured through an image sensor or light signal entered through the image sensor to identify at least one of at least one line element, face element, and color element, and generate colorable content (e.g., online coloring content or online coloring book content) based on at least one of the line element, face element, and color element identified. The processor 410 may delete at least some color elements from at least some colored areas of the generated colorable content or vary the color attribute (e.g., color, brightness, or chroma) of some color elements.

According to an embodiment of the present disclosure, the processor 410 may provide a user interface for providing colorable content. For example, the user interface may be an execution screen of a coloring-related application that provides colorable content.

According to an embodiment of the present disclosure, the processor 410 may display, on the display 420, the coloring-related user interface based on the texture attribute of the first image. The user interface may include graphical objects (e.g., text, images (e.g., preview image), icons, or menu) corresponding to at least one second image in which the texture attribute of the first image has changed.

The processor 410 may select one of the graphical objects corresponding to at least one second image and display, on the display 420, the final image including at least one line element for the second image corresponding to the selected graphical object. For example, the processor 410 may perform selection by the user's input.

According to an embodiment of the present disclosure, the processor 410 may provide a user interface including the final image and at least one graphical object corresponding to the coloring function for coloring the final image. The user interface may include graphical objects corresponding to the coloring function by various coloring tools (or coloring materials) and at least one graphical object corresponding to the color information for coloring.

According to an embodiment of the present disclosure, the above-described image processing schemes are not limited thereto, and other various schemes may also be adopted for such image processing purposes. The colors are not limited to those listed above, and other various colors may be used as well.

According to an embodiment of the present disclosure, the display 420 may display the final image (or colorable content) including the plurality of colorable areas formed by at least one line element.

According to an embodiment of the present disclosure, the display 420 may display a user interface for providing colorable content.

According to an embodiment of the present disclosure, the display 420 may display a user interface for coloring the final image.

According to an embodiment of the present disclosure, the display 420 may include a touchscreen and receive input through the touchscreen. The input may be an input (e.g., a touch, drag, pinch in/out, swipe or hovering) by an input device such as a stylus or the user's finger or other body part.

According to an embodiment of the present disclosure, the sensor 430 may include an image sensor and obtain the first image (or raw image) through the image sensor. For example, the first image may be an image captured by the camera.

According to an embodiment of the present disclosure, the communication module 440 may communicate with an external electronic device. For example, the communication module 440 may deliver a signal for sending a request for at least one content (e.g., image or colorable content) to the external electronic device and receive at least one colorable content from the external electronic device.

According to an embodiment of the present disclosure, the memory 450 may store information intended for providing colorable content (e.g., final image). For example, the memory 450 may store the first image, at least one second image, and the final image and store at least one content received from the external electronic device.

According to an embodiment of the present disclosure, the electronic device 400 may comprise a display 420, a processor 410 electrically connected to the display 420, and a memory 450 electrically connected with the processor 410, wherein the memory 450 may store instructions executed to enable the processor 410 to obtain a first image, receive a first input, change a texture attribute of the first image based on the first input to generate at least one second image, generate a final image including a plurality of colorable areas based on at least one color element for one selected from among the at least one second image, and display the final image through the display 420.

According to an embodiment of the present disclosure, the final image may correspond to the first image, and the plurality of colorable areas may be formed by a plurality of line elements distinguished from each other.

According to an embodiment of the present disclosure, the instructions may enable the processor 410 to classify at least one color element for the selected second image, receive a second input, select a complexity for the second image based on the second input, determine at least part of the at least one color element classified as a similar color element based on the selected complexity, and generate the plurality of colorable areas based on the determined similar color element.

According to an embodiment of the present disclosure, the texture attribute may include a line attribute for a line element representing a boundary between colors having different attributes, a face attribute for a face element forming a closed area by the line element, and a color attribute for a color element.

According to an embodiment of the present disclosure, the instructions may enable the processor 410 to change the boundary between the face elements having different texture attributes to generate the at least one second image.

According to an embodiment of the present disclosure, the instructions may enable the processor 410 to analyze each of at least one face element to extract a color value of at least one color element, generate at least one face area including a set of face elements where at least part of the at least one extracted color value has a color value not less than a threshold, generate at least one third image including the at least one face area, generate the at least one second image based on the at least one third image generated, and combine the first image with at least one of the at least one third image to generate the at least one second image.

According to an embodiment of the present disclosure, the instructions may enable the processor 410 to insert a pattern image to at least part of the at least one face area. According to an embodiment of the present disclosure, the instructions may enable the processor 410 to change a texture attribute for at least one face element corresponding to a second area other than a first area of the first image to generate the at least one second image.

According to an embodiment of the present disclosure, the instructions may enable the processor 410 to select at least one pattern area from among at least one pattern area inserted to the selected second image, identify positions of a plurality of input points corresponding to a third input as per the third input, determine a distance between the plurality of input points based on the identified positions, determine a pattern complexity for the at least one selected pattern area based on the determined distance, and adjust the size or number of the at least one pattern area based on the determined pattern complexity.

According to an embodiment of the present disclosure, an electronic device 400 may comprise a display, a processor 410 electrically connected to the display 420, and a memory 450 electrically connected with the processor, wherein the memory 450 may store instructions executed to enable the processor 410 to obtain a first image, change a texture attribute of the first image to generate at least one second image, insert a pattern image to at least part of one selected from among the at least one second image, select at least one pattern area from among at least one pattern area of the inserted pattern image, identify positions of a plurality of input points corresponding to an input, determine a distance between the plurality of input points based on the identified positions, determine a pattern complexity for the at least one selected pattern area based on the determined distance, and adjust the size or number of the at least one pattern area based on the determined pattern complexity.

FIG. 5 is a block diagram illustrating program modules for execution in an execution environment of an electronic device according to an embodiment of the present disclosure.

Referring to FIG. 5, an execution environment 500 may include a classifying module 510, a managing module 520, a content generating module 530, a content playing module 540, and a service providing module 550.

According to an embodiment of the present disclosure, the classifying module 510 may obtain first content, identify the file type of the obtained first content, and deliver information about the identified file type to the managing module 520. For example, the information about the file type may include an image file type (e.g., jpg, tiff, png, or bmp) or content file type playable by the content playing module 540.

According to an embodiment of the present disclosure, the managing module 520 may deliver the obtained first content to the content generating module 530 or the content playing module 540 based on the information about the file type. For example, where the first content is an image, the managing module 520 may deliver the first content to the content generating module 530, and where the first content is second content playable on the content playing module 540, the managing module 520 may deliver the first content to the content playing module 540.

According to an embodiment of the present disclosure, where the obtained first content is a first image, the managing module 520 may vary the texture attribute for the first image to generate at least one candidate image and deliver the at least one candidate image generated to the content generating module 530. For example, the managing module 520 may vary the texture attribute based on designated setting information or user's selection (or input).

According to an embodiment of the present disclosure, the content generating module 530 may perform image processing on the first content to generate second content which can be played on the content playing module 540 and deliver the generated second content to the content playing module 540.

According to an embodiment of the present disclosure, the content playing module 540 may play the second content and deliver the played second content to the service providing module 550.

According to an embodiment of the present disclosure, the service providing module 550 may provide the played second content.

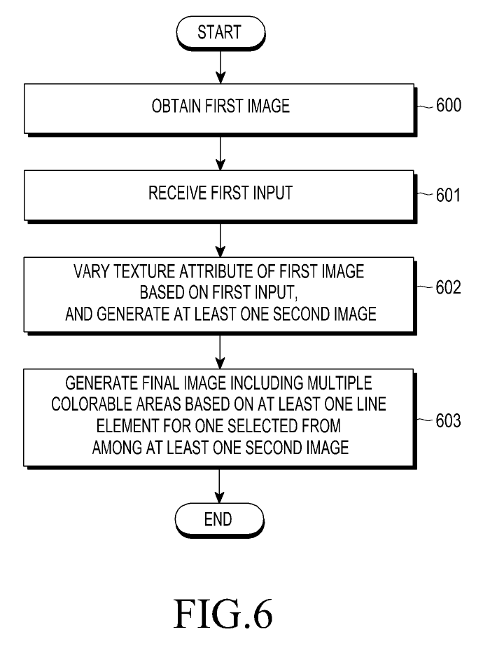

FIG. 6 is a flowchart illustrating a method for providing colorable content in an electronic device according to an embodiment of the present disclosure.

According to an embodiment of the present disclosure, operations 600 to 603 may be performed by any one of the electronic device 101, 102, 104, 201, or 400, the server 106, the processor 120, 210, or 410, or the program module 310.

Referring to FIG. 6, in operation 600, the electronic device 400 (e.g., the processor 410) may obtain a first image.

In operation 601, the electronic device 400 (e.g., the processor 410) may receive a first input. For example, the first input may be the user's input (e.g., a touch).

In operation 602, the electronic device 400 (e.g., the processor 410) may vary the texture attribute of the first image and generate at least one second image. For example, the electronic device 400 (e.g., the processor 410) may vary the line attribute, face attribute, or color attribute of the first image, generating at least one second image having a different texture attribute.

In operation 603, the electronic device 400 (e.g., the processor 410) may provide a final image including a plurality of colorable areas based on at least one line element for one selected from among at least one second image.

According to an embodiment of the present disclosure, a method for an electronic device 400 may comprise obtaining a first image, receiving a first input, changing a texture attribute of the first image based on the first input to generate at least one second image, and generating a final image including a plurality of colorable areas based on at least one color element for one selected from among the at least one second image.

According to an embodiment of the present disclosure, the final image may correspond to the first image, and the plurality of colorable areas may be formed by a plurality of line elements distinguished from each other.

According to an embodiment of the present disclosure, generating the final image may include classifying at least one color element for the selected second image, receiving a second input, selecting a complexity for the second image based on the second input, determining at least part of the at least one color element classified as a similar color element based on the selected complexity, and generating the plurality of colorable areas based on the determined similar color element.

According to an embodiment of the present disclosure, the texture attribute may include a line attribute for a line element representing a boundary between colors having different attributes, a face attribute for a face element forming a closed area by the line element, and a color attribute for a color element.

According to an embodiment of the present disclosure, each of the at least one second image may have a different texture attribute.

According to an embodiment of the present disclosure, generating the at least one second image may include analyzing each of at least one face element to extract a color value of at least one color element, generating at least one face area including a set of face elements where at least part of the at least one extracted color value has a color value not less than a threshold, generating at least one third image including the at least one face area, generating the at least one second image based on the at least one third image generated, and combining the first image with at least one of the at least one third image to generate the at least one second image.

According to an embodiment of the present disclosure, the method for an electronic device 400 may further comprise inserting a pattern image to at least part of the at least one face area.

According to an embodiment of the present disclosure, generating the at least one second image may include dividing an image corresponding to a first area of the first image and changing a texture attribute for at least one face element corresponding to a second area other than the first area in the first image to generate the at least one second image.

According to an embodiment of the present disclosure, the method for an electronic device 400 may further comprise selecting at least one pattern area from among at least one pattern area inserted to the selected second image, identifying positions of a plurality of input points corresponding to a third input as per the third input, determining a distance between the plurality of input points based on the identified positions, determining a pattern complexity for the at least one selected pattern area based on the determined distance, and adjusting the size or number of the at least one pattern area based on the determined pattern complexity.

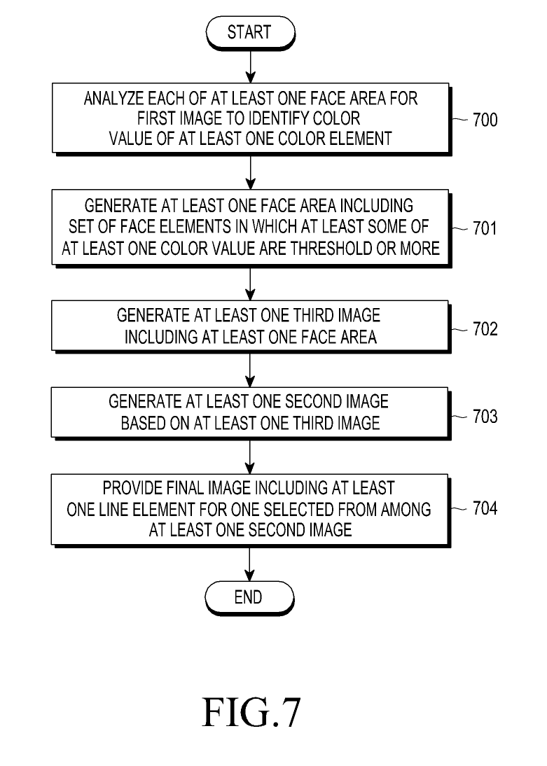

FIG. 7 is a flowchart illustrating a method for providing colorable content in an electronic device according to an embodiment of the present disclosure.

According to an embodiment of the present disclosure, operations 700 to 704 may be performed by any one of the electronic device 101, 102, 104, 201, or 400, the server 106, the processor 120, 210, or 410, or the program module 310.

Referring to FIG. 7, in operation 700, the electronic device 400 (e.g., the processor 410) may analyze each of at least one face element for the first image to identify the color value of at least one color element.

In operation 701, the electronic device 400 (e.g., the processor 410) may generate at least one face area including a set of face elements where at least part of the at least one extracted color value has a color value not less than a threshold value.

In operation 702, the electronic device 400 (e.g., the processor 410) may generate at least one third image including at least one face area. For example, the at least one third image may include a third image including a first face area having a first color value or/and a third image including a second face area having a second color value.

In operation 703, the electronic device 400 (e.g., the processor 410) may generate at least one second image based on the at least one third image. For example, the electronic device 400 (e.g., the processor 410) may merge the first image and at least some of the at least one third image, generating at least one second image.

In operation 704, the electronic device 400 (e.g., the processor 410) may provide the final image including at least one line element for one selected from among the at least one second image.

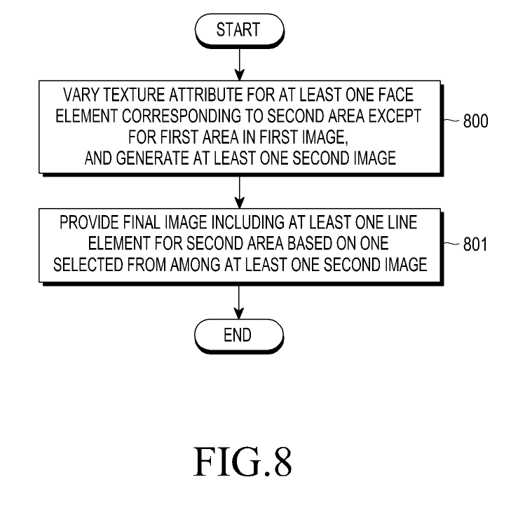

FIG. 8 is a flowchart illustrating a method for providing colorable content in an electronic device according to an embodiment of the present disclosure.

According to an embodiment of the present disclosure, operations 800 to 801 may be performed by any one of the electronic device 101, 102, 104, 201, or 400, the server 106, the processor 120, 210, or 410, or the program module 310.

Referring to FIG. 8, in operation 800, the electronic device 400 (e.g., the processor 410) may change the texture attribute for at least one face element corresponding to a second area other than a first area of the first image and generate at least one second image.

In operation 801, the electronic device 400 (e.g., the processor 410) may provide the final image including at least one line element for the second area based on the one selected from among the at least one second image.

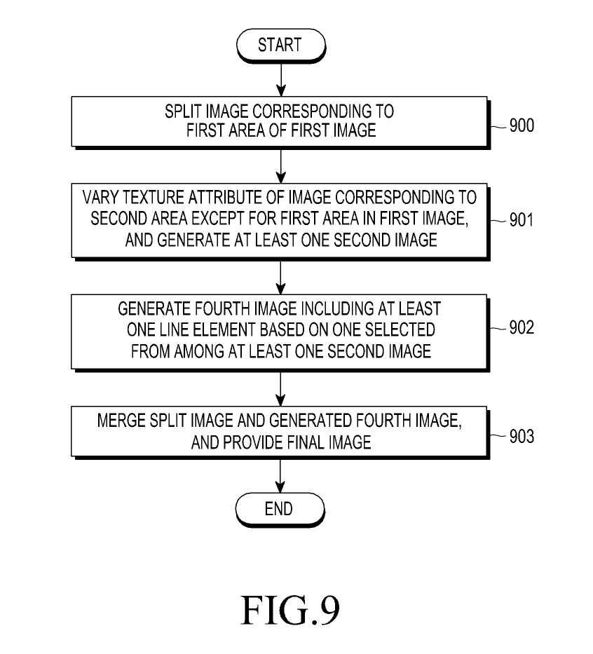

FIG. 9 is a flowchart illustrating a method for providing colorable content in an electronic device according to an embodiment of the present disclosure.

According to an embodiment of the present disclosure, operations 900 to 903 may be performed by any one of the electronic device 101, 102, 104, 201, or 400, the server 106, the processor 120, 210, or 410, or the program module 310.

Referring to FIG. 9, in operation 900, the electronic device 400 (e.g., the processor 410) may split the image corresponding to the first area of the first image.

In operation 901, the electronic device 400 (e.g., the processor 410) may change the texture attribute of the image corresponding to the second area except for the first area in the first image and generate at least one second image.

In operation 902, the electronic device 400 (e.g., the processor 410) may generate a fourth image including at least one line element based on one selected from among the at least one second image.

In operation 903, the electronic device may merge the split image and the generated fourth image and generate the final image. For example, the electronic device 400 (e.g., the processor 410) may merge the fourth image including at least some line elements indicating the boundary between the face elements (or face areas) corresponding to the second area and the partial image as split, corresponding to the first area of the first image, generating the final image.

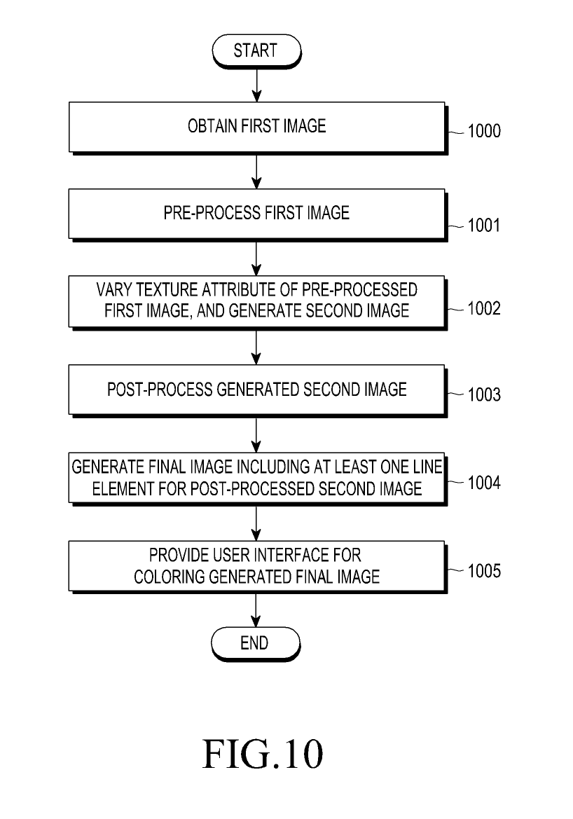

FIG. 10 is a flowchart illustrating a method for providing colorable content in an electronic device according to an embodiment of the present disclosure.

According to an embodiment of the present disclosure, operations 1000 to 1005 may be performed by any one of the electronic device 101, 102, 104, 201, or 400, the server 106, the processor 120, 210, or 410, or the program module 310.

Referring to FIG. 10, in operation 1000, the electronic device 400 (e.g., the processor 410) may obtain a first image.

In operation 1001, the electronic device 400 (e.g., the processor 410) may pre-process the first image. For example, the electronic device 400 (e.g., the processor 410) may perform image processing to adjust the resolution of the first image or remove noise from the first image.

In operation 1002, the electronic device 400 (e.g., the processor 410) may vary the texture attribute of the pre-processed first image and generate the second image. For example, the electronic device 400 (e.g., the processor 410) may vary the texture attribute of the first image as per the user's input or based on pre-designated setting information.

In operation 1003, the electronic device 400 (e.g., the processor 410) may post-process the generated second image. For example, the electronic device 400 (e.g., the processor 410) may perform image processing to enhance the quality of the second image.

In operation 1004, the electronic device 400 (e.g., the processor 410) may generate the final image including at least one line element for the post-processed second image. For example, the electronic device 400 (e.g., the processor 410) may identify at least one line element indicating the boundary between the face elements (or face areas) constituting the second image and generate the final image including at least one line element identified. The generated final image may include a plurality of colorable areas formed by at least one line element.

In operation 1005, the electronic device 400 (e.g., the processor 410) may provide a user interface for coloring the generated final image. For example, the user interface may include an area for displaying the final image, a graphical object corresponding to a function for at least one coloring tool for coloring the final image, and a graphical object corresponding to a function for selecting at least one color for coloring.

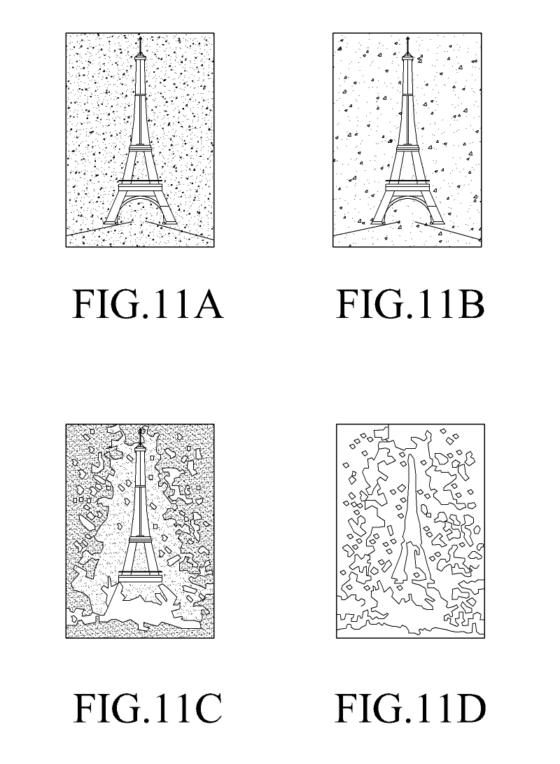

FIGS. 11A, 11B, 11C, and 11D are a view illustrating examples of a first image, a second image, and a final image according to an embodiment of the present disclosure.

Referring to FIGS. 11A to 11D, the electronic device 400 (e.g., the processor 410) may obtain a first image as shown in FIG. 11A, pre-process the obtained first image, and obtain the pre-processed first image as shown in FIG. 11B.

The electronic device 400 (e.g., the processor 410) may generate face areas including a set of face elements having at least partially the same color information based on the color information (e.g., color, brightness, and chroma) about each of the face elements included in the pre-processed first image, as shown in FIG. 11C. For example, the electronic device 400 (e.g., the processor 410) may identify the brightness value or chroma value fr the face elements having the same color, and when they have different brightness values or chroma values, the electronic device 400 (e.g., the processor 410) may determine that they are face elements having different color information.

The electronic device 400 (e.g., the processor 410) may generate the second image including the generated face areas, identify at least one line element indicating the boundary between the face areas included in the generated second image, and generate the final image including at least one line element identified, as shown in FIG. 11D.

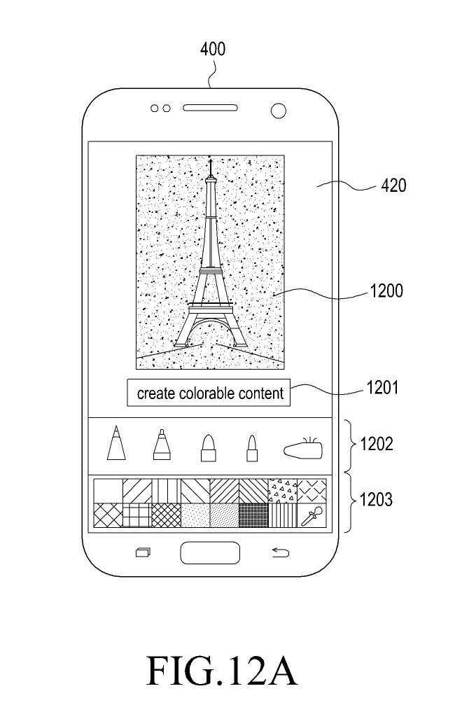

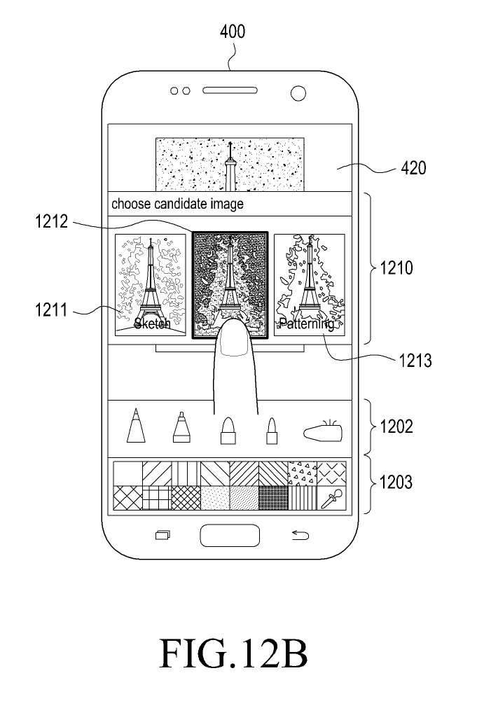

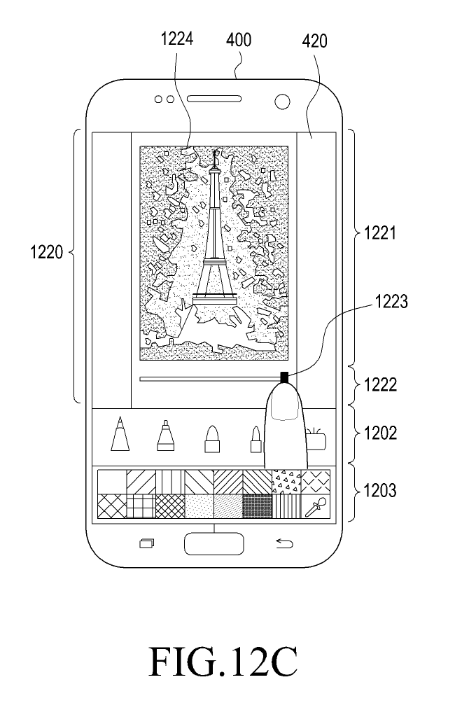

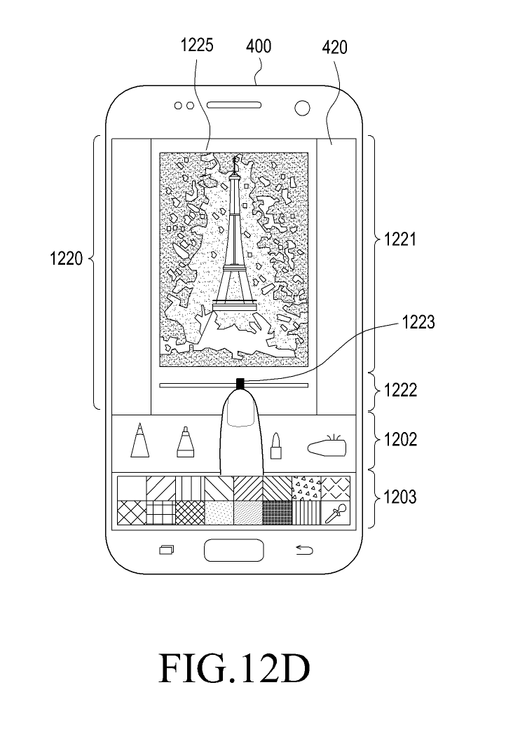

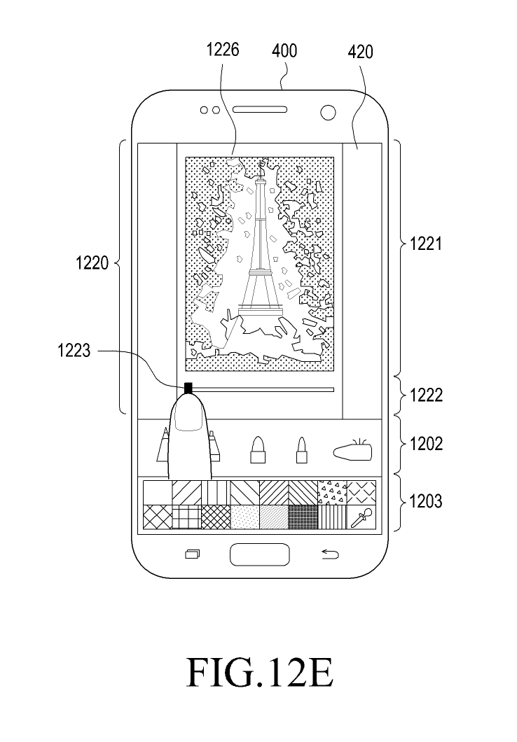

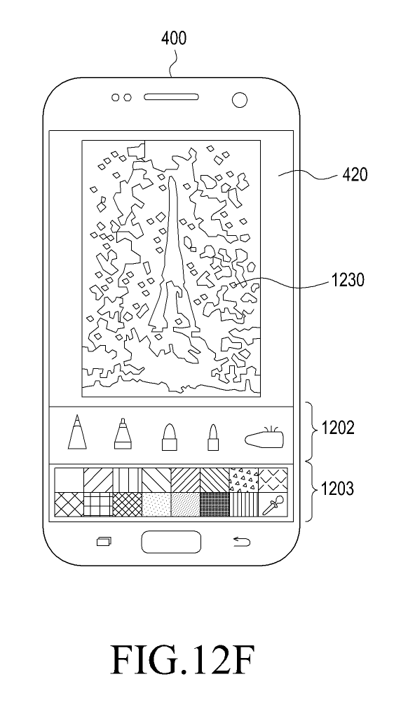

FIGS. 12A, 12B, 12C, 12D, 12E, and 12F are views illustrating examples of a coloring-related user interface according to an embodiment of the present disclosure.

Referring to FIG. 12A, the electronic device 400 (e.g., the processor 410) may display, on the display 420, a user interface for varying the texture attribute of the first image for generating colorable content to generate at least one second image. For example, the user interface may include a preview image area 1200 for previewing the obtained first image, a first graphical object 1201 corresponding to a function for generating colorable content related to the first image, second graphical objects corresponding to the coloring function by a plurality of coloring tools 1202, and third graphical objects 1203 corresponding to various colors for coloring.

Referring to FIG. 12B, the electronic device 400 (e.g., the processor 410) may display a user interface 1210 for varying the texture attribute of the first image as per a first input (e.g., a touch input) to the first graphical object 1201 through the touchscreen to generate at least one second image (e.g., candidate image).

For example, the user interface 1210 may include a preview image (e.g., a first preview image 1211, a second preview image 1212, or a third preview image 1213) corresponding to a function for generating at least one second image having a different texture attribute and for previewing at least one second image generatable by the function.

For example, the first preview image 1211 may correspond to a function for varying the color information about at least one face element included in the first image to a grayscale based on at least one piece of color information. The second preview image 1212 may correspond to a function for generating the second image including at least one face area which is a set for face elements having similar color information based on the color information about at least one face element included in the first image. The third preview image 1213 may correspond to a function for inserting a pattern image to at least part of the generated second image.

According to an embodiment of the present disclosure, the electronic device 400 (e.g., the processor 410) may provide a user interface 1220 for adjusting the degree (or size or scale) of variation of the texture attribute for the second image corresponding to the selected second preview image 1212 as shown in FIG. 12C. The user interface 1220 may include a preview image area 1221 for the second image having the texture attribute that is varied by the adjustment of the status bar 1223 and a status bar area 1222 for adjusting the degree of variation of the texture attribute for the second image.

According to an embodiment of the present disclosure, the electronic device 400 (e.g., the processor 410) may move the status bar 1223 to the left or right as per at least one of a touch or drag using the touchscreen, adjusting the degree of variation of the texture attribute for the second image. For example, the electronic device 400 (e.g., the processor 410) may determine face elements having similar color information (or color values not less than a threshold) among at least one face element included in the second image using different threshold color information which is selected by moving the status bar 1223 to the left or right.

Referring to FIGS. 12C, 12D, 12E, and 12F, the electronic device 400 (e.g., the processor 410) may determine the face elements having similar color information using first threshold color information when the status bar 1223 is positioned on the left as shown in FIG. 12C. For example, when the difference in the color value (or brightness value or chroma value) between at least one face element is smaller than a first threshold color value (or first threshold brightness value or first threshold chroma value), the electronic device 400 (e.g., the processor 410) may determine that they have similar color information. The electronic device 400 (e.g., the processor 410) may provide the first preview image 1224 for the second image including a set for at least one face element so determined.

When the status bar 1223 is positioned on the middle as shown in FIG. 12D, the electronic device 400 (e.g., the processor 410) may determine face elements having similar color information using second threshold color information (e.g., a second threshold color value, second threshold brightness value, or second threshold chroma value) having a value larger than the first threshold color information. For example, when the difference in the color value between at least one face element is smaller than the second threshold color value which is larger than the first threshold color value, the electronic device 400 (e.g., the processor 410) may determine that they have similar color information. The electronic device 400 (e.g., the processor 410) may provide the second preview image 1225 for the second image including a set for at least one face element so determined. Since the second preview image 1225 are determined to have more similar color values than the first preview image 1224, the second preview image 1225 may have fewer color values than the first preview image 1224.

When the status bar 1223 is positioned on the right as shown in FIG. 12E, the electronic device 400 (e.g., the processor 410) may determine face elements having similar color information using third threshold color information (e.g., a third threshold color value, third threshold brightness value, or third threshold chroma value) having a value larger than the first and second threshold color information. For example, when the difference in the color value between at least one face element is smaller than the third threshold color value which is larger than the first and second threshold color value, the electronic device 400 (e.g., the processor 410) may determine that they have similar color information. The electronic device 400 (e.g., the processor 410) may provide the third preview image 1226 for the second image including a set for at least one face element so determined. Since the third preview image 1226 are determined to have more similar color values than the first and second preview images 1224 and 1225, the third preview image 1226 may have fewer color values than the first and second preview images 1224 and 1225.

Referring to FIG. 12F, the electronic device 400 (e.g., the processor 410) may identify at least one line element representing the boundary between the plurality of face areas included in the generated second image and generate a final image (or a preview image for the final image) 1230 including at least one line element identified.

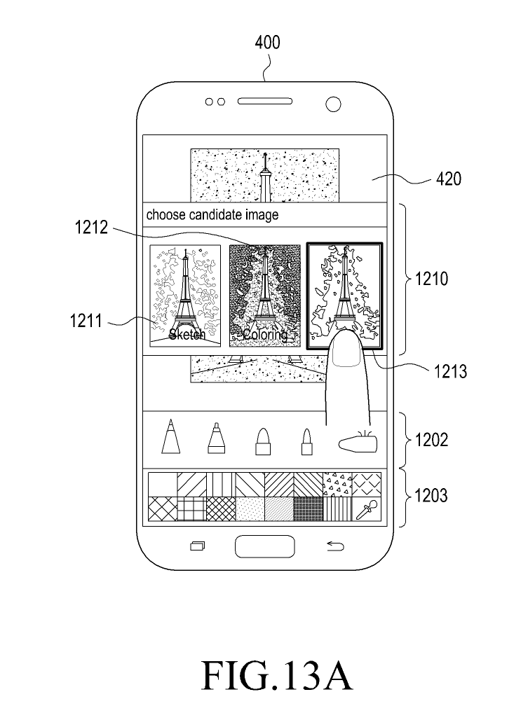

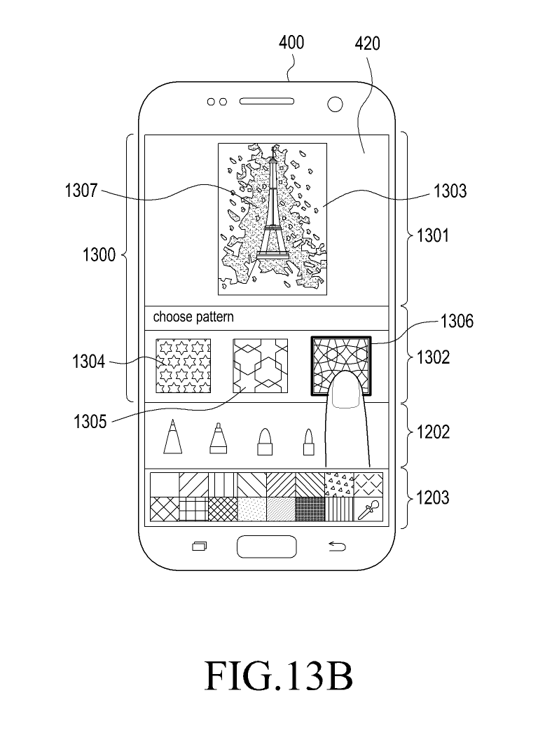

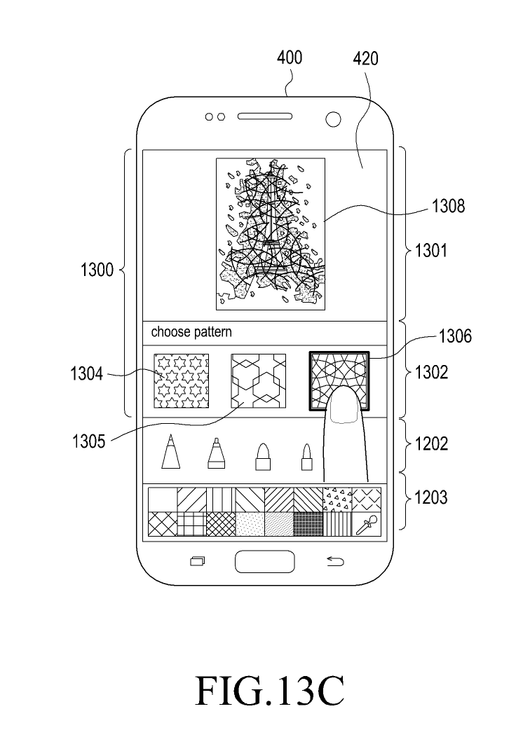

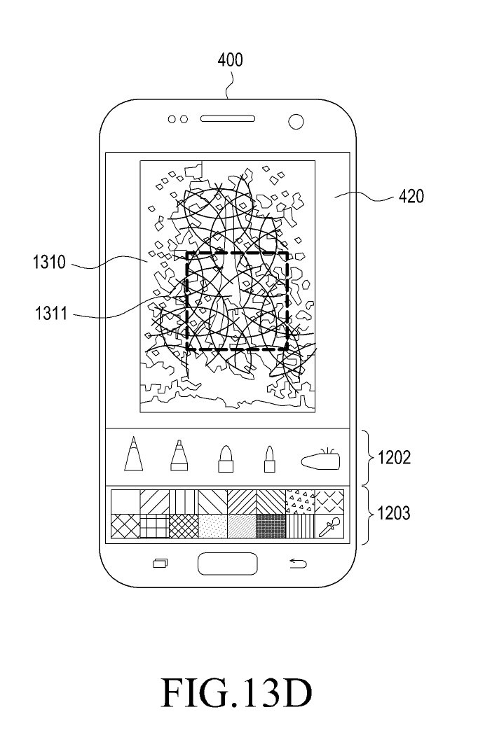

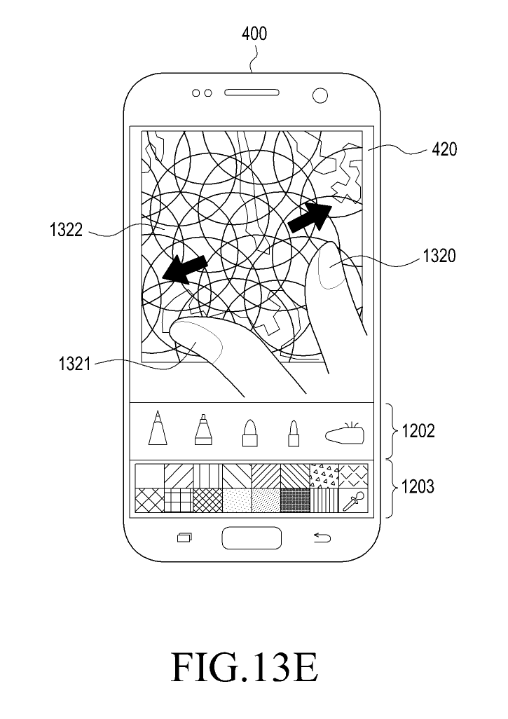

FIGS. 13A, 13B, 13C, 13D, and 13E are views illustrating examples of a coloring-related user interface according to an embodiment of the present disclosure.

Referring to FIG. 13A, the electronic device 400 (e.g., the processor 410) may provide a user interface 1300 for inserting a pattern image to at least part of the second image corresponding to the third preview image 1213 selected as shown in FIG. 13B as per an input for selecting the third preview image 1213.

Referring to FIG. 13B, the user interface 1300 may include a preview image area 1301 including a preview image 1303 for the second image and a pattern selection area 1302 including graphical objects (e.g., icons) 1304, 1305, and 1306 corresponding to a plurality of pattern images insertable. The pattern selection area 1302 may include a first graphical object 1304 corresponding to a first pattern image, a second graphical object 1305 corresponding to a second pattern image, and a third graphical object 1306 corresponding to a third pattern image.

According to an embodiment of the present disclosure, the electronic device 400 (e.g., the processor 410) may insert the third pattern image corresponding to the third graphical object 1306 to at least part of the second image as per an input (e.g., a touch input) for selecting the third graphical object 1306 and provide a preview image 1308 for a fifth image having the third pattern image inserted thereto as shown in FIG. 13C. For example, the electronic device 400 (e.g., the processor 410) may insert the third pattern image to a first face area 1307 having first color information (e.g., orange) as shown in FIG. 13B.

Referring to FIGS. 13D and 13E, the electronic device 400 (e.g., the processor 410) may identify at least one line element representing the boundary between the face areas included in the fifth image and generate a final image (or a preview image for the final image) 1310 including at least one line element identified.

The electronic device 400 (e.g., the processor 410) may display a magnified image 1322 for a particular area 1311 of the final image as per an input (e.g., a pinch in) 1320 or 1321 using the touchscreen. For example, in the magnified image 1322, the size of the enclosed areas corresponding to the magnified image 1322 may be smaller than the size of the enclosed areas corresponding to the particular area 1311, and the number of enclosed areas corresponding to the magnified image 1322 may be larger than the number of enclosed areas corresponding to the particular area 1311.

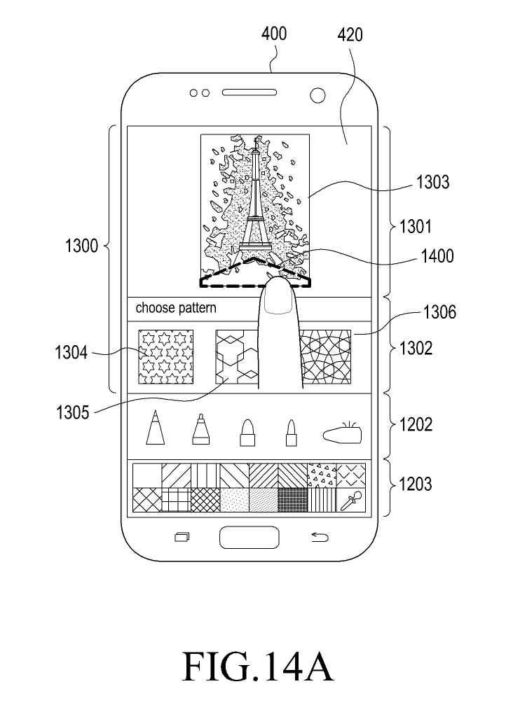

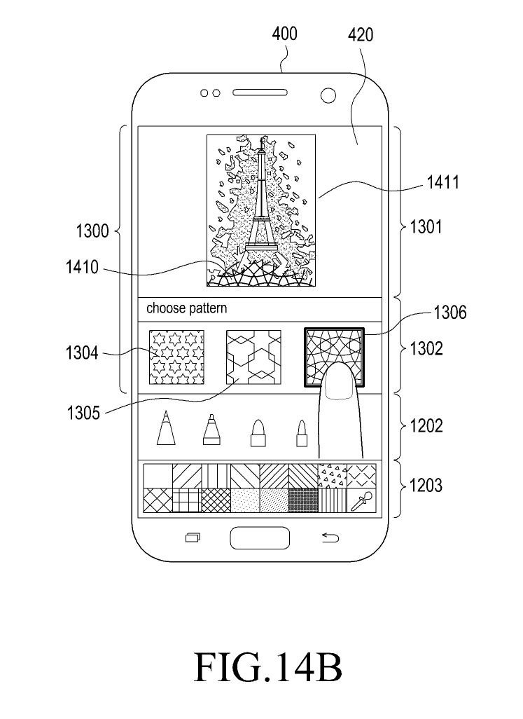

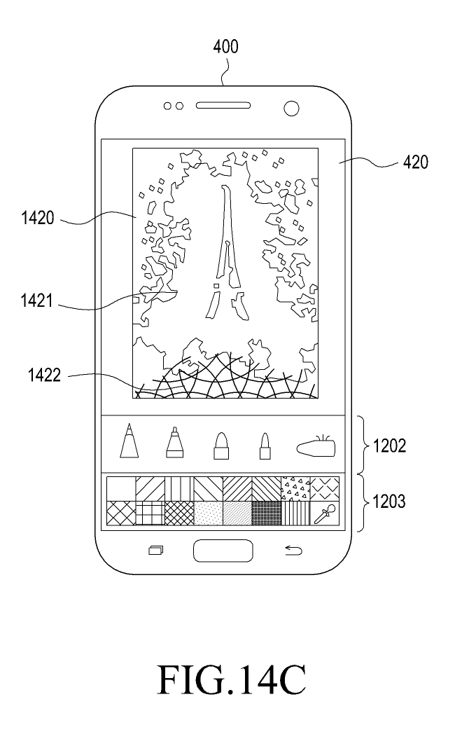

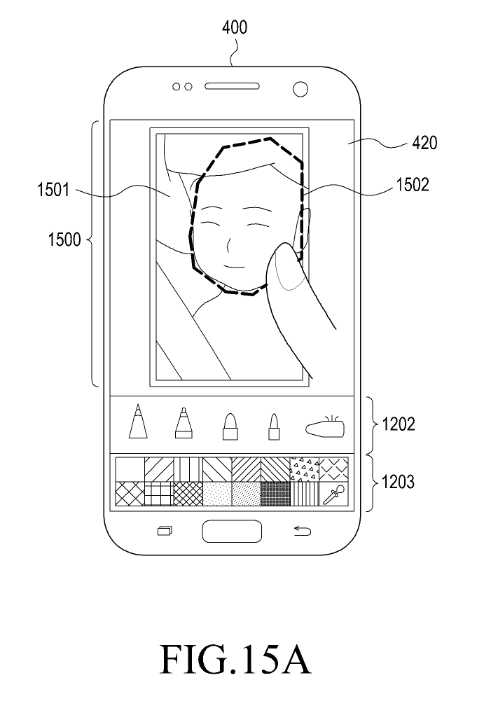

FIGS. 14A, 14B, and 14C are views illustrating examples of a coloring-related user interface according to an embodiment of the present disclosure.

Referring to FIG. 14A, the electronic device 400 (e.g., the processor 410) may select at least part of the second image for adding a pattern image. For example, the electronic device 400 (e.g., the processor 410) may select at least part 1400 of the second image (or the preview image for the second image) 1303 by an input (e.g., a touch or drag) using the touchscreen. The at least part 1400 of the second image may correspond to the trajectory along which the user's finger, stylus, or other input means moves from the first position touched back to the first position on the touchscreen.

Referring to FIG. 14B, the electronic device 400 (e.g., the processor 410) may insert (or add, or combine) the selected third pattern image 1410 to at least part 1400 of the second image 1303 as per (or in response to) an input for selecting the third graphical object 1306 related to the third pattern image to generate a fifth image and provide the generated fifth image (or a preview image for the fifth image) 1411.

Referring to FIG. 14C, the electronic device 400 (e.g., the processor 410) may identify at least one line element representing the boundary between the plurality of face areas included in the fifth image and generate and display a final image (or a preview image for the final image) 1420 including at least one line element identified. The generated final image 1420 may include at least one line element 1421 indicating the boundary between the face elements constituting the final image 1420, at least one line element 1422 indicating the boundary between the face elements constituting the inserted information, and colorable areas (or face areas) formed by at least one line element.

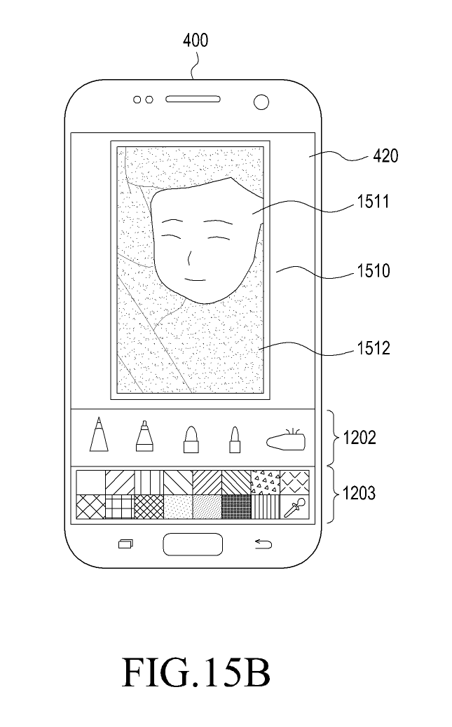

FIGS. 15A and 15B are views illustrating examples of a coloring-related user interface according to an embodiment of the present disclosure.

Referring to FIG. 15A, according to an embodiment of the present disclosure, the electronic device 400 (e.g., the processor 410) may provide a user interface 1500 for selecting at least part (or portion, or partial area) of the first image to generate the final image in which the rest except for the at least part selected has been varied for its texture attribute. The user interface 1500 may include a preview image 1501 for the first image.

For example, the electronic device 400 (e.g., the processor 410) may select at least part of the preview image 1501 for the first image as per an input using the touchscreen. The electronic device 400 (e.g., the processor 410) may further display a graphical object 1502 (e.g., dotted lines) to indicate the at least part selected.

The electronic device 400 (e.g., the processor 410) may vary the texture attribute of the rest except for the at least part selected, generating at least one second image. The electronic device 400 (e.g., the processor 410) may identify at least one line element included in the one selected from among the at least one second image generated and generate the final image including at least one line element identified. The rest except for the at least part in the generated final image may include at least one colorable area.

According to an embodiment of the present disclosure, the electronic device 400 (e.g., the processor 410) may split the image of the at least part selected and identify at least one line element included in the rest except for the image of the at least part split, generating the fourth image including the at least one line element identified. The electronic device 400 (e.g., the processor 410) may merge the split image and the generated fourth image, generating the final image. In the final image, the area corresponding to the fourth image may include at least one colorable area.

Referring to FIG. 15B, the electronic device 400 (e.g., the processor 410) may display the generated final image (or a preview image for the final image) 1510. For example, the final image 1510 may include a part 1511 of the raw image corresponding to the third area and at least one colorable area constituted of at least one line element 1512 corresponding to the rest except for the third area.

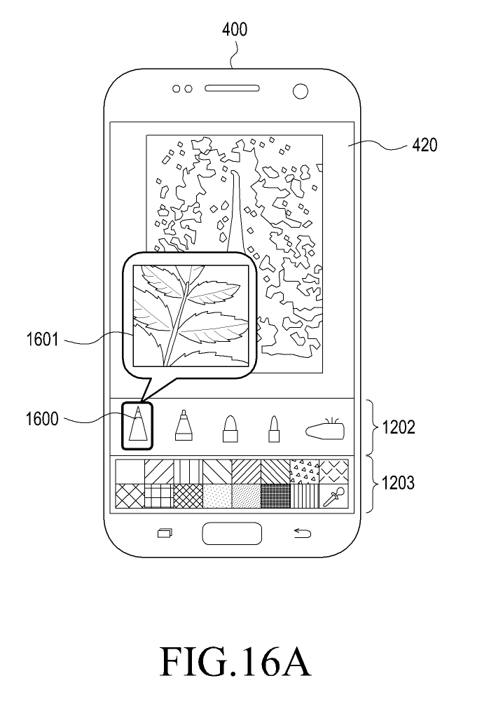

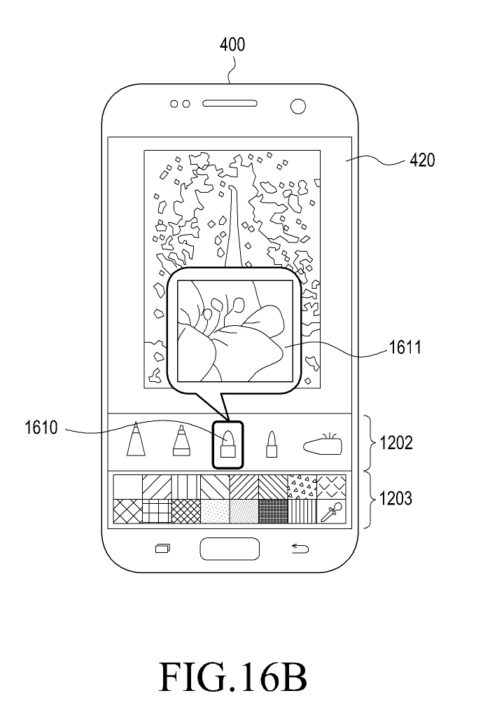

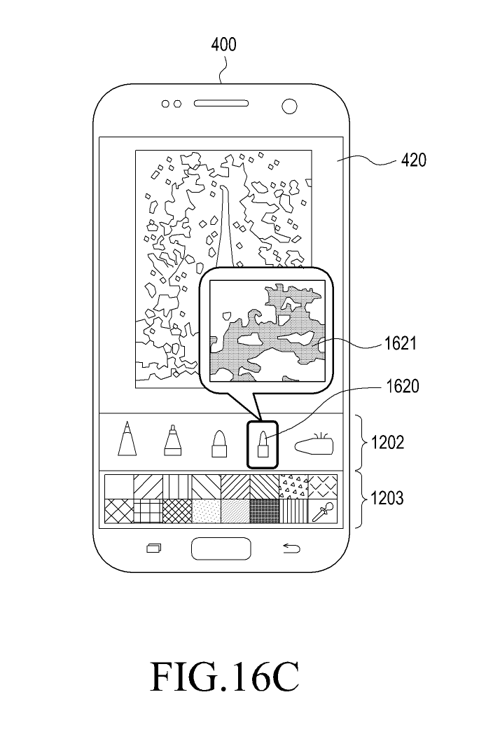

FIGS. 16A, 16B, and 16C are views illustrating examples of a coloring-related user interface according to an embodiment of the present disclosure.

Referring to FIG. 16A, the electronic device 400 (e.g., the processor 410) may select a first graphical object 1600 (e.g., a color pencil) corresponding to a first coloring tool from among graphical objects corresponding to the coloring function for a plurality of coloring tools as per an input (e.g., a touch) using the touchscreen. The electronic device 400 (e.g., the processor 410) may include a first preview image 1601 related to the first coloring tool corresponding to the selected first graphical object 1600. For example, the first preview image 1601 may be a preview image for the image colored with the first coloring tool.

Referring to FIG. 16B, the electronic device 400 (e.g., the processor 410) may select a second graphical object 1610 (e.g., a brush or watercolor) corresponding to a second coloring tool from among the graphical objects corresponding to the coloring function for the plurality of coloring tools as per an input using the touchscreen. The electronic device 400 (e.g., the processor 410) may include a second preview image 1611 related to the second coloring tool corresponding to the selected second graphical object 1610. For example, the second preview image 1611 may be a preview image for the image (e.g., a watercolor painting image) colored with the second coloring tool.

Referring to FIG. 16C, the electronic device 400 (e.g., the processor 410) may select a third graphical object 1620 (e.g., a brush or oil color) corresponding to a third coloring tool from among the graphical objects corresponding to the coloring function for the plurality of coloring tools as per an input using the touchscreen. The electronic device 400 (e.g., the processor 410) may include a third preview image 1621 related to the third coloring tool corresponding to the selected third graphical object 1620. For example, the third preview image 1621 may be a preview image for the image (e.g., an oil painting image) colored with the third coloring tool.

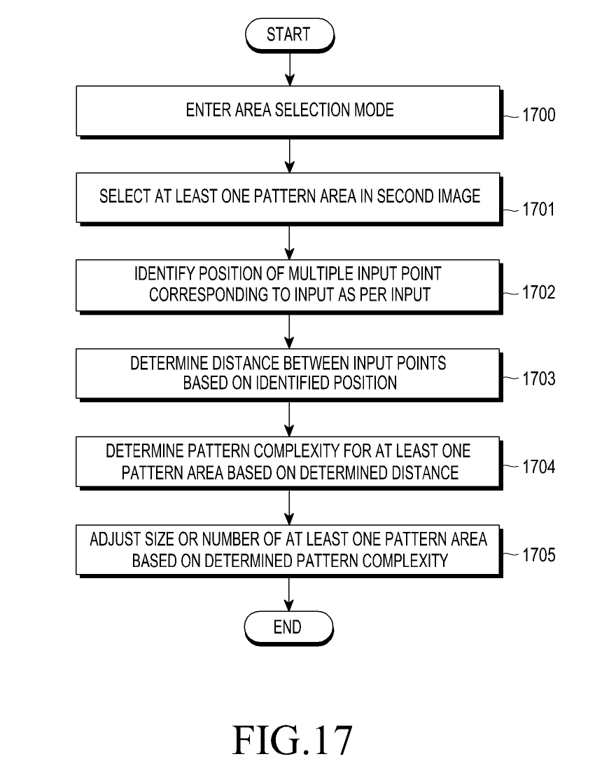

FIG. 17 is a flowchart illustrating the operation of changing the complexity of a pattern image in an electronic device according to an embodiment of the present disclosure.

According to an embodiment of the present disclosure, operations 1700 to 1705 may be performed by any one of the electronic device 101, 102, 104, 201, or 400, the server 106, the processor 120, 210, or 410, or the program module 310.

Referring to FIG. 17, in operation 1700, the electronic device 400 (e.g., the processor 410) may enter an area selection mode. For example, the electronic device 400 (e.g., the processor 410) may enter the area selection mode as per an input. The input may include a touch, long press, or force touch on the touchscreen of the display 420. The area selection mode may be a mode for selecting at least one pattern area in the pattern image inserted to at least part of the second image.

In operation 1701, the electronic device 400 (e.g., the processor 410) may select at least one pattern area from the second image. For example, the electronic device 400 (e.g., the processor 410) may select at least one pattern area as per an input. The input may include a touch or touch-drag-and-drop.

According to an embodiment of the present disclosure, the electronic device 400 (e.g., the processor 410), upon sensing a first touch input, may identify the position of the sensed first touch input and select a first area corresponding to the identified position. Upon sensing a drag input after the first touch input, the electronic device 400 (e.g., the processor 410) may identify the position of the drag input and select a second area or third area corresponding to the identified drag input. Upon failing to sense an input within a preset time of sensing the drop input, the electronic device 400 (e.g., the processor 410) may terminate the area selection.

In operation 1702, the electronic device 400 (e.g., the processor 410) may identify the position of a plurality of input points corresponding to an input as per the input. The input may include a pinch in/out.

According to an embodiment of the present disclosure, the electronic device 400 (e.g., the processor 410) may identify the coordinates (e.g., x coordinate and y coordinate) of the plurality of input points (e.g., a first input point and second input point) as per the pinch in/out input.

In operation 1703, the electronic device 400 (e.g., the processor 410) may determine the distance between the plurality of input points based on the identified position.

According to an embodiment of the present disclosure, the electronic device 400 (e.g., the processor 410) may determine the distance between the coordinate of the first input point and the coordinate of the second input point. For example, the electronic device 400 (e.g., the processor 410) may determine the distance between the first input point and the second input point using the difference in x coordinate between the first input point and the second input point and the difference in y coordinate between the first input point and the second input point.

In operation 1704, the electronic device 400 (e.g., the processor 410) may determine the pattern complexity for at least one pattern area based on the determined distance.

According to an embodiment of the present disclosure, the electronic device 400 (e.g., the processor 410) may determine whether the determined distance is larger than 0 and is equal or smaller than a first threshold distance that is previously set.

When the determined distance (e.g., the first distance) is larger than the first threshold distance and is smaller than the second threshold distance which is larger than the first threshold distance, the electronic device 400 (e.g., the processor 410) may determine a first pattern complexity as the pattern complexity for the at least one pattern area. The first pattern complexity may be a value set to allow at least one pattern area to have a first size and a first number.

When the determined distance (e.g., the second distance) is larger than the second threshold distance, the electronic device 400 (e.g., the processor 410) may determine a second pattern complexity as the pattern complexity for the at least one pattern area. The second pattern complexity may be a value set to allow at least one pattern area to have a second size, smaller than the first size, and a second number, larger than the first number.

When the determined distance (e.g., the third distance) is smaller than the first threshold distance, the electronic device 400 (e.g., the processor 410) may determine a third pattern complexity as the pattern complexity for the at least one pattern area. The third pattern complexity may be a value set to allow at least one pattern area to have a third size, larger than the first size, and a third number, smaller than the first number.

In operation 1705, the electronic device 400 (e.g., the processor 410) may adjust the size or number of the at least one pattern area based on the determined pattern complexity.

According to an embodiment of the present disclosure, the electronic device 400 (e.g., the processor 410) may vary at least one pattern area to have the first size and first number based on the first pattern complexity.

According to an embodiment of the present disclosure, the electronic device 400 (e.g., the processor 410) may vary the at least one pattern area to have the second size, which is smaller than the first size, and the second number, which is larger than the first number, based on the second pattern complexity.

According to an embodiment of the present disclosure, the electronic device 400 (e.g., the processor 410) may vary the at least one pattern area to have the third size, which is larger than the first size, and the third number, which is smaller than the first number, based on the third pattern complexity.

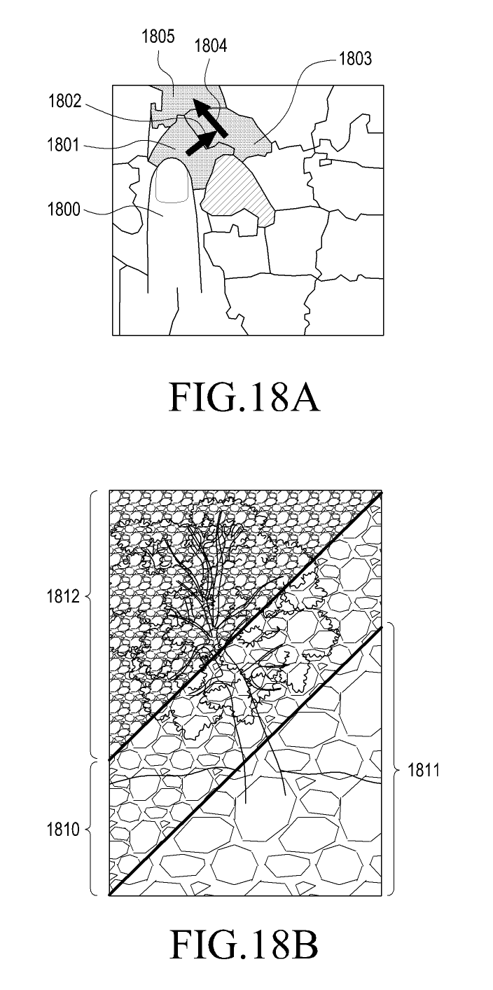

FIGS. 18A and 18B are views illustrating examples of the operation of changing the complexity of a pattern area in an electronic device according to an embodiment of the present disclosure.

Referring to FIG. 18A, the electronic device 400 may enter the area selection mode as per a first input and select at least one pattern area as per a second input (e.g., a touch or touch-drag-and-drop).

For example, upon sensing a touch input in the first position by the finger 1800, the electronic device 400 may select a first pattern area 1801 corresponding to the first position. For example, upon sensing a drag input in the second position by the finger 1800, the electronic device 400 may select a first pattern area 1803 corresponding to the first position. Upon sensing a drag-and-drop-input in the third position in the second arrow direction 1804 by the finger 1800, the electronic device 400 may select the third pattern area 1805 corresponding to the third position. Upon sensing no input for a preset time, the electronic device 400 may terminate the selection of pattern area.

Referring to FIG. 18B, the electronic device 400 may determine the distance between a plurality of input points as per a pinch in/out input, determine a pattern complexity based on the determined distance, and adjust the size or number of at least one pattern area based on the determined pattern complexity.

For example, where the determined distance is a first distance, the electronic device 400 may vary at least one pattern area to have a first size and a first number based on first pattern complexity. At least one pattern area set thus may be shown as denoted in reference number 1810 of FIG. 18B.

Where the determined distance is a second distance, the electronic device 400 may set at least one pattern area to have a second size, which is larger than the first size, or a second number, which is smaller than the first number, based on the second pattern complexity. At least one pattern area set thus may be shown as denoted in reference number 1811 of FIG. 18B.

Where the determined distance is a third distance, the electronic device 400 may set at least one pattern area to have a third size, which is smaller than the first size, or a third number, which is larger than the first number, based on the third pattern complexity. At least one pattern area set thus may be shown as denoted in reference number 1812 of FIG. 18B.

According to various embodiments of the present disclosure, there may be colorable content using the user's desired images, providing coloring book content fitting the user's skill level while satisfying all users whether they are beginners or the skilled.

According to an embodiment of the present disclosure, there may be provided a non-transitory recording medium storing commands to execute a method for controlling an electronic device, the commands configured to be executed by at least one processor to enable the at least one processor to perform at least one operation comprising obtaining a first image, receiving a first input, changing a texture attribute of the first image based on the first input to generate at least one second image, and generating a final image including a plurality of colorable areas based on at least one color element for one selected from among the at least one second image.

As used herein, the term “module” includes a unit configured in hardware, software, or firmware and may interchangeably be used with other terms, e.g., “logic,” “logic block,” “part,” or “circuit.” The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. The computer-readable medium may include, e.g., a hard disk, a floppy disc, a magnetic medium (e.g., magnetic tape), an optical recording medium (e.g., compact disc-read only memory (CD-ROM), digital versatile disc (DVD), magnetic-optical medium (e.g., floptical disk), or an embedded memory. The instruction may include a code created by a compiler or a code executable by an interpreter. Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, in parallel, repeatedly or heuristically, or at least some operations may be executed in a different order or omitted or other operations may be added.

As is apparent from the foregoing description, according to various embodiments, there may be provided coloring book content that may satisfy all users, whether they are beginners or the skilled, by allowing them to use their desired images (e.g., photos or pictures).

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display;
at least one processor electrically connected to the display; and
a memory electrically connected with the at least one processor, wherein the memory stores instructions, when executed, enable the at least one processor to:
obtain a first image,
receive a first input,
change a texture attribute of the first image based on the first input to generate at least one second image,
generate a final image including a plurality of colorable areas based on at least one color element for a second image selected from among the at least one second image, and
display the final image through the display.

2. The electronic device of claim 1,
wherein the final image corresponds to the first image, and
wherein the plurality of colorable areas is formed by a plurality of line elements distinguished from each other.

3. The electronic device of claim 1, wherein the instructions further enable the at least one processor to:
classify at least one color element for the selected second image,
receive a second input,
select a complexity for the second image based on the second input,
determine at least part of the at least one color element classified as a similar color element based on the selected complexity, and
generate the plurality of colorable areas based on the determined similar color element.

4. The electronic device of claim 1, wherein the texture attribute includes a line attribute for a line element representing a boundary between colors having different attributes, a face attribute for a face element forming an enclosed area by the line element, and a color attribute for the color element.

5. The electronic device of claim 3, wherein the at least one second image each has a different texture attribute.

6. The electronic device of claim 5, wherein the instructions further enable the at least one processor to:
analyze each of at least one face element to extract a color value of at least one color element,
generate at least one face area including a set of face elements where at least part of the at least one extracted color value has a color value not less than a threshold,
generate at least one third image including the at least one face area,
generate the at least one second image based on the at least one third image generated, and
combine the first image with at least one of the at least one third image to generate the at least one second image.

7. The electronic device of claim 6, wherein the instructions further enable the at least one processor to:
insert a pattern image to at least part of the at least one face area.

8. The electronic device of claim 3, wherein the instructions further enable the at least one processor to:
change a texture attribute for at least one face element corresponding to a second area other than a first area of the first image to generate the at least one second image.

9. The electronic device of claim 1, wherein the instructions further enable the at least one processor to:
select at least one pattern area from among at least one pattern area inserted to the selected second image,
identify positions of a plurality of input points corresponding to a third input as per the third input,
determine a distance between the plurality of input points based on the identified positions,
determine a pattern complexity for the at least one selected pattern area based on the determined distance, and
adjust the size or number of the at least one pattern area based on the determined pattern complexity.

10. A method for an electronic device, the method comprising:
obtaining a first image;
receiving a first input;
changing a texture attribute of the first image based on the first input to generate at least one second image; and
generating a final image including a plurality of colorable areas based on at least one color element for a second image selected from among the at least one second image.

11. The method of claim 10,
wherein the final image corresponds to the first image, and
wherein the plurality of colorable areas is formed by a plurality of line elements distinguished from each other.

12. The method of claim 10, wherein the generating of the final image comprises:
classifying at least one color element for the selected second image,
receiving a second input,
selecting a complexity for the second image based on the second input, determining at least part of the at least one color element classified as a similar color element based on the selected complexity, and
generating the plurality of colorable areas based on the determined similar color element.

13. The method of claim 12, wherein the texture attribute includes a line attribute for a line element representing a boundary between colors having different attributes, a face attribute for a face element forming an enclosed area by the line element, and a color attribute for the color element.

14. The method of claim 12, wherein the at least one second image each has a different texture attribute.

15. The method of claim 12, wherein the generating of the at least one second image comprises:
analyzing each of at least one face element to extract a color value of at least one color element,
generating at least one face area including a set of face elements where at least part of the at least one extracted color value has a color value not less than a threshold, generating at least one third image including the at least one face area,
generating the at least one second image based on the at least one third image generated, and
combining the first image with at least one of the at least one third image to generate the at least one second image.

16. The method of claim 15, further comprising:
inserting a pattern image to at least part of the at least one face area.

17. The method of claim 12, wherein the generating of the at least one second image comprises:
dividing an image corresponding to a first area of the first image, and changing a texture attribute for at least one face element corresponding to a second area other than the first area in the first image to generate the at least one second image.

18. The method of claim 12, further comprising:
selecting at least one pattern area from among at least one pattern area inserted to the selected second image;
identifying positions of a plurality of input points corresponding to a third input as per the third input;
determining a distance between the plurality of input points based on the identified positions;
determining a pattern complexity for the at least one selected pattern area based on the determined distance; and
adjusting the size or number of the at least one pattern area based on the determined pattern complexity.

19. An electronic device comprising:
a display;
at least one processor electrically connected to the display; and
a memory electrically connected with the at least one processor, wherein the memory stores instructions, when executed, enable the at least one processor to:
obtain a first image,
change a texture attribute of the first image to generate at least one second image,
insert a pattern image to at least part of a second image selected from among the at least one second image,
select at least one pattern area from among at least one pattern area of the inserted pattern image,
identify positions of a plurality of input points corresponding to an input, determine a distance between the plurality of input points based on the identified positions, determine a pattern complexity for the at least one selected pattern area based on the determined distance, and
adjust the size or number of the at least one pattern area based on the determined pattern complexity.

20. A non-transitory recording medium storing commands to execute a method for controlling an electronic device, the commands, when executed by at least one processor, enable the at least one processor to perform at least one operation, the at least one operation comprising:
obtaining a first image;
receiving a first input;
changing a texture attribute of the first image based on the first input to generate at least one second image; and
generating a final image including a plurality of colorable areas based on at least one color element for a second image selected from among the at least one second image.
